(19) United States
(12) Patent Application Publication
(10) Pub. No.: US 2012/0331378 A1
(43) Pub. Date: Dec. 27, 2012

(54) SYSTEM AND METHOD FOR TIMELINE VISUALIZATION AND INTERACTION

(75) Inventor: Andrei BAIOURA, Redmond, WA (US)

(73) Assignee: DIGITALVIEWS, INC., Redmond, WA (US)

(21) Appl. No.: 13/492,734

(22) Filed: Jun. 8, 2012

Related U.S. Application Data
(60) Provisional application No. 61/500,058, filed on Jun. 22, 2011.

(51) Int. Cl. G06F 17/00

(52) U.S. Cl. 715/243

(57) ABSTRACT

A system and method for visualizing and displaying calendar and timeline data in an intuitive and easily-manipulated manner. In an embodiment, a computer system application may implement a method for reading data from a data store of timeline elements wherein each timeline elements having associated data and an associated context. The data for a timeline element may include data such as start time, end time, span, title, and other information typically associated with a calendar entry. Context may be relationships defined for displaying a timeline event within a layout and visualization scheme such as size of the timeline element, display relationship with respect to a timeline, display relationship with respect to levels or containers, and display relationship with respect to other timeline events.

### CROSS REFERENCE TO RELATED APPLICATION

This application claims priority from U.S. Provisional Application No. 61/500,058 titled, “SYSTEM AND METHOD FOR TIMELINE VISUALIZATION AND INTERACTION,” which was filed on Jun. 22, 2011, and which is incorporated by reference.

### BACKGROUND

Users of computers have continued need for displaying and modifying data associated with time. Examples of such use may include, but are not limited to, project management applications, personal journals, calendars, reservation systems, etc. Often, the amount of data exceeds what can be displayed at simultaneously and only a portion of data can be presented at once. This presents a need for a system which can provide efficient visualizations of different parts of the same timeline and enable intuitive transitions between these visualizations, allowing a user to keep the context of the observed data. Another problem this scenario presents is performing a search within a timeline and visualizing the search results in a manner that is efficient and intuitive.

Another problem timeline presentation systems typically encounter is displaying objects associated with overlapping periods in time. While automatic arrangement can be performed by a system, often times it would greatly improve the visual result if the user could specify preferences for arranging such objects. This presents a need for a system which can provide an intuitive interface for specifying particular preferences as well as methods for displaying the requested arrangement.

Also, in many cases, a user may need to modify objects associated with time. While such changes can be visualized after they are made final, it may help to visually assess various changes as changes are being made through a “preview” mechanism. This, in turn, presents a need for a user interface which supports dynamic changes to the timeline objects and which provides the ability to visualize the effect of the changes in progress in an intuitive manner.

### BRIEF DESCRIPTION OF THE DRAWINGS

The foregoing aspects and many of the attendant advantages of the claims will become more readily appreciated as the same become better understood by reference to the following detailed description, when taken in conjunction with the accompanying drawings, wherein:

FIG. 1 is a block diagram showing a system for providing timeline visualization and interaction in accordance with an embodiment of the subject matter disclosed herein.

FIG. 2 is a block diagram showing, by way of example, a timeline data store in accordance with an embodiment of the subject matter disclosed herein.

FIG. 3 is a high-level block diagram showing, by way of example, interactions between the timeline visualization and interaction system embodied in an application, timeline data store and input and output devices of FIG. 1 in accordance with an embodiment of the subject matter disclosed herein.

FIG. 4 is a flow diagram showing a high-level method for timeline visualization and interaction system operation in accordance with an embodiment of the subject matter disclosed herein.

FIG. 5 is a layout showing, by way of example, a timeline visualization in accordance with an embodiment of the subject matter disclosed herein.

FIG. 6 is a layout showing, by way of example, an individual timeline element visualization in accordance with an embodiment of the subject matter disclosed herein.

FIG. 7 is an exemplary layout of timeline element visualizations within a timeline element container in accordance with an embodiment of the subject matter disclosed herein.

FIG. 8 is an exemplary layout which may represent a portion of layout discussed in relation to FIG. 7 with different viewport positioning.

FIG. 9 is a flow diagram showing, by way of example, a method for laying out timeline element within a timeline element container in accordance with an embodiment of the subject matter disclosed herein.

FIG. 10 is a flow diagram depicting an exemplary method for sequencing element layout within a container in accordance with an embodiment of the subject matter disclosed herein.

FIG. 11 is an exemplary arrangement in which timeline elements whose desired bracket intervals intersect with presentation viewport are arranged between timeline element containers in accordance with an embodiment of the subject matter disclosed herein.

FIG. 12 is an exemplary arrangement of a different visualization of the same view as one discussed in relation to FIG. 11 with different viewport positioning.

FIG. 13 is an exemplary tabular representation of per-view element data which may be stored in a timeline data store as part of per-view element information discussed in relation to FIG. 2.

FIG. 14 is a flow diagram depicting an exemplary method for arranging timeline elements between containers in accordance with an embodiment of the subject matter disclosed herein.

FIG. 15 is an exemplary layout which displays to a viewport a plurality of timeline elements which represent results of a search performed in a view in accordance with an embodiment of the subject matter disclosed herein.

FIG. 16 is a flow diagram depicting an exemplary method for displaying timeline blocks for layout discussed in relation to FIG. 15.

FIG. 17 is an exemplary UI manipulation, which allows changing mutual arrangement of timeline elements by pushing element down to a container with lower level in accordance with an embodiment of the subject matter disclosed herein.

FIG. 18 is an exemplary UI manipulation, which allows changing mutual arrangement of timeline elements by pushing element up to a container with higher level in accordance with an embodiment of the subject matter disclosed herein.

FIG. 19 is an exemplary UI manipulation, which allows pushing elements to appear in a container with higher level in accordance with an embodiment of the subject matter disclosed herein.

FIG. 20 is a flow diagram showing, by way of example, a method for adjusting z-value and minlevel of element being manipulated using drag operations discussed in relation to FIGS. 17-19.

FIG. 21 is a flow diagram showing, by way of example, a method for visualizing intermediate states of manipulations of FIGS. 17-20.

FIG. 22 is an exemplary UI manipulation, which allows changing timespan of a timeline element in accordance with an embodiment of the subject matter disclosed herein.

FIG. 23 is exemplary UI manipulations, which may be applied to gap blocks and modify their properties in accordance with an embodiment of the subject matter disclosed herein.

FIG. 24 is exemplary UI manipulation, which allows modifying scale of a timeline blocks in accordance with an embodiment of the subject matter disclosed herein.

FIG. 25 illustrates an exemplary visualization for a viewport in which timeline elements are arranged between bands according to an embodiment of the subject matter disclosed herein.

FIG. 26 illustrates an exemplary UI manipulation which takes place in a viewport and allows placing timeline elements into a new band according to an embodiment of the subject matter disclosed herein.

FIG. 27 is a flow diagram depicting an exemplary procedure 2700 for adjusting timeline element arrangement between bands according to an embodiment of the subject matter disclosed herein.

FIG. 28 illustrates an exemplary visualization of a timeline viewport in which optimized vertical layout is utilized to position timeline elements according to an embodiment of the subject matter disclosed herein.

FIG. 29 is a flow diagram for an exemplary method for calculating vertical positions for timeline element and its neighbor element within a container according to an embodiment of the subject matter disclosed herein.

FIG. 30 is a flow diagram for an exemplary method for calculating z-value for a timeline element according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

By way of overview, the subject matter disclosed herein may be directed to a system and method for visualizing and displaying calendar and timeline data in an intuitive and easily-manipulated manner. In an embodiment, a computer system application may implement a method for reading data from a data store of timeline elements wherein each timeline elements having associated data and an associated context. The data for a timeline element may include data such as start time, end time, span, title, and other information typically associated with a calendar entry. Context may be relationships defined for displaying a timeline event within a layout and visualization scheme such as size of the timeline element, display relationship with respect to a timeline, display relationship with respect to levels, containers or bands, and display relationship with respect to other timeline elements.

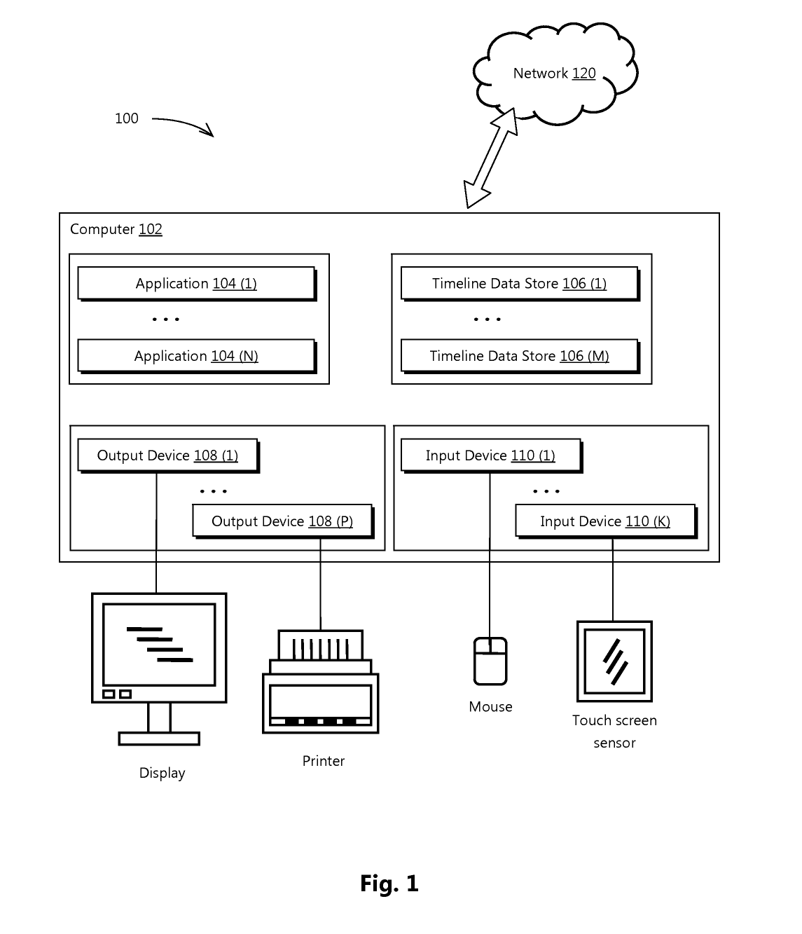

Thus, timeline elements may be displayed according to the associated data and the associated context. When being displayed, the system may determine if any timeline elements has an associated context that would interfere with the associated context of any other timeline element when displayed. If an interference is determined; the display of one or more of the timeline elements may be changed according its associated context in relation to others. Further, a user may define specific relationships and contexts according to a user's preferences. In this manner, a more intuitive and user-friendly calendaring system may be achieved. These and other aspects may be more readily understood by way of the following descriptions with respect to FIGS. 1-30.

### Computing Environment

FIG. 1 is an illustration of an exemplary environment 100 in which a computer 102 is capable of providing timeline visualization and interaction services. The computer 102, as illustrated, may be configured as a personal computer; however the computer 102 may also assume a variety of other configurations, such as notebook computer, slate computer, smart phone, etc.

The computer 102 may include a plurality of input devices 110(1) . . . 110(K). Illustrated input devices in FIG. 1 include a mouse and a touch screen sensor, but other input devices may also be used, such as computer keyboard, joystick, etc. The computer 102 may also include a plurality of output devices 108(1) . . . 106(P). Illustrated output devices in FIG. 1 include a computer display and a printer, but other output devices can also be used, such as television set, projector, etc.

The computer 102 may also be configured to communicate over a network 120. Network 120 may represent the internet as well as other networks, such as an intranet, wired or wireless networks etc. Network 120 may provide access to the data stored on different computers or devices.

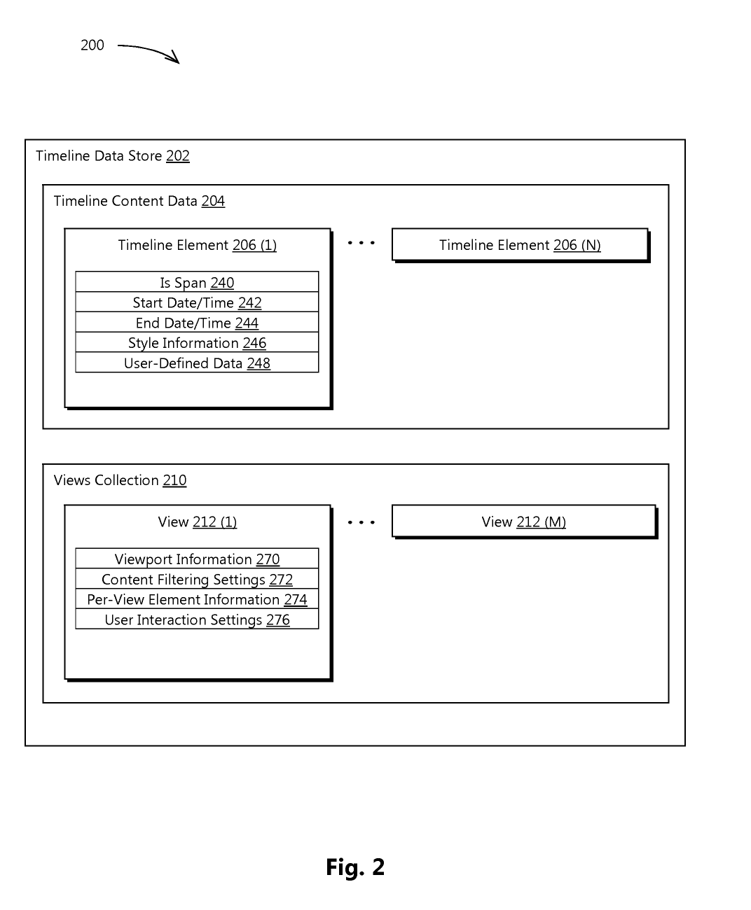

Further, the computer 102 may have access to a plurality of timeline data stores 106(1) . . . 106(M). For example, each of the plurality of the timeline data stores 106(1) . . . 106(M) may reside locally on the computer 102, or may reside on a different computer or multiple computers and be accessed via network 120. Further discussion about timeline data stores and the data contained within can be found in relation to FIG. 2.

The computer 102 may also include a plurality of applications 104(1) . . . 104(N) which may be configured to access one or more of the timeline data stores 106(1), . . . , 106(M) and render visualizations of the data contained in these stores. The plurality of output devices 108(1) . . . 108(P) may be configured to display those visualizations of the timeline data to the user. Further, the plurality of input devices 110(1) . . . 110(K) may be configured to receive the user input and control the execution of applications 104(1) . . . 104(N). For example, the user input may be used to change the visualization parameters or modify the contents of the timeline data stores.

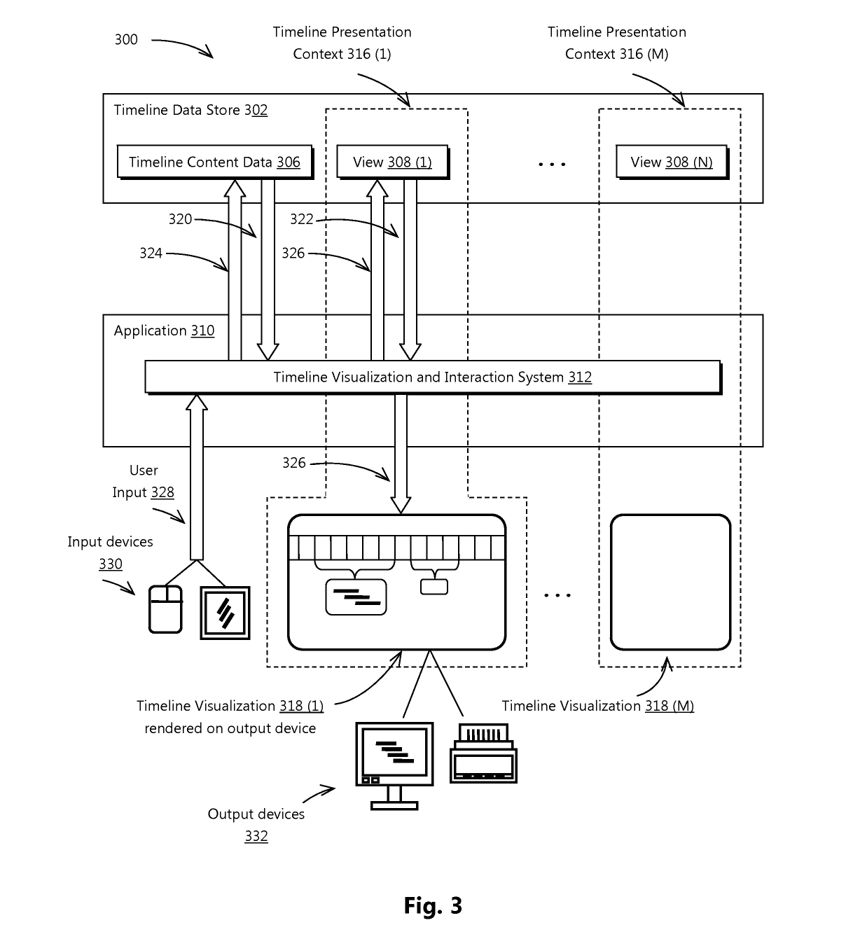

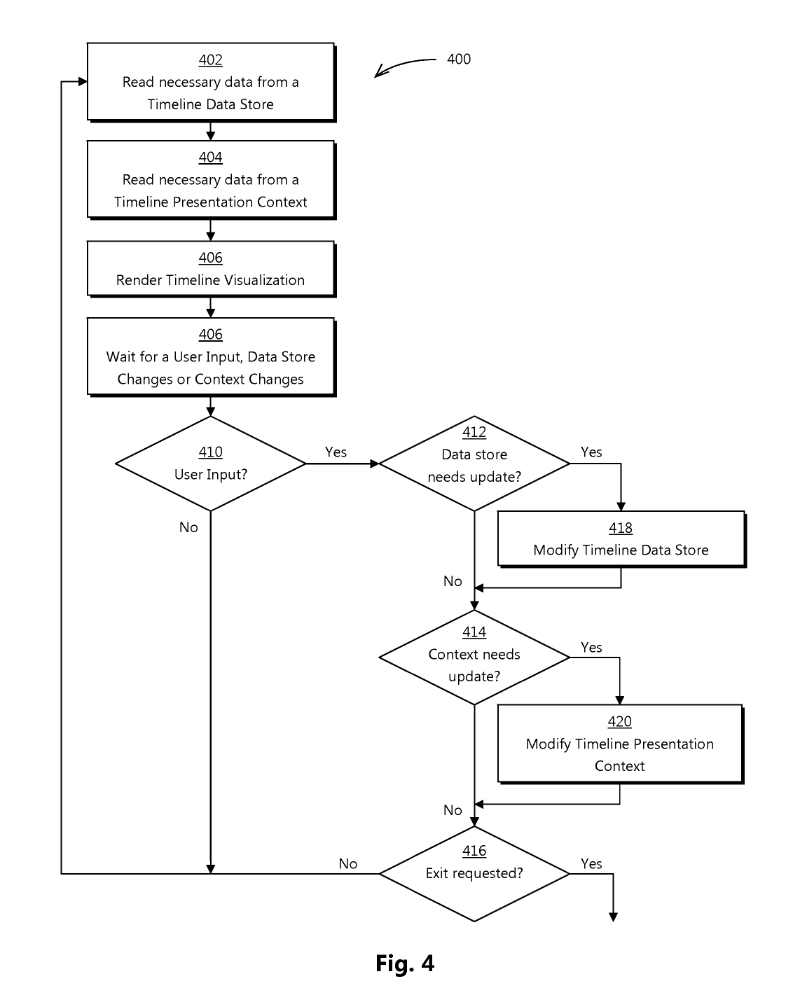

Thus, each of the plurality of the applications 104(1), . . . , 104(N) may embody a timeline visualization and interaction system implemented in software which may provide a user interface for visualization and modification of the timeline data. Further details about timeline visualization and interaction system operation can be found in relation to FIGS. 3-4.

FIG. 2 is a high level block diagram 200 of an exemplary timeline data store 202. Timeline data store 202 represents a collection of timeline data that is logically related in some way. For example, a timeline data store may represent all timeline data of a specific user or a schedule of a project. Timeline data store may reside on any computer-readable media, for example hard disk, flash memory, etc. Timeline data store 202 may include two sub-stores: timeline content data 204 and views collection 210. It is understood that timeline data store 202 may also contain additional data if required by a particular implementation or embodiment.

Timeline content data 204 contains a plurality of timeline elements 206(1) . . . 206 (N). It is understood that timeline content data 204 may also contain additional data if required by a particular implementation or embodiment.

Each of the plurality of the timeline elements 206(1), . . . , 206 (N) represents a binding between some user-defined data 248, and a placement in time defined by a span property 240, start date/time 242, end date/time 244 and style information 246. User-defined data 248 may, for example, contain text or an html block, a bitmap, a video, etc. Form and content of the user-defined data 248 depends on the implementation or embodiment. The span property 240 indicates whether given timeline element is associated with a point in time or with a time span. In the case of a point in time, start date/time 242 represents this point in time and end date/time can be ignored. In the case of a time span, start date/time 242 and end date/time 244 represent start and end points of a time span, respectively. Form of the time placement information depends on the implementation or embodiment. Style information 246 may contain details about how this timeline element should be visualized and that is intrinsic to the element 206(n). Form and content of the style information 246 depends on the particular implementation or embodiment. It is also understood that timeline elements 206(1) . . . 206 (N) may also contain additional data if required by a particular implementation or embodiment.

Views collection 210 contains a plurality of views 212(1) . . . 212 (M). It is understood that views collection 210 may also contain additional data if required by a particular implementation or embodiment.

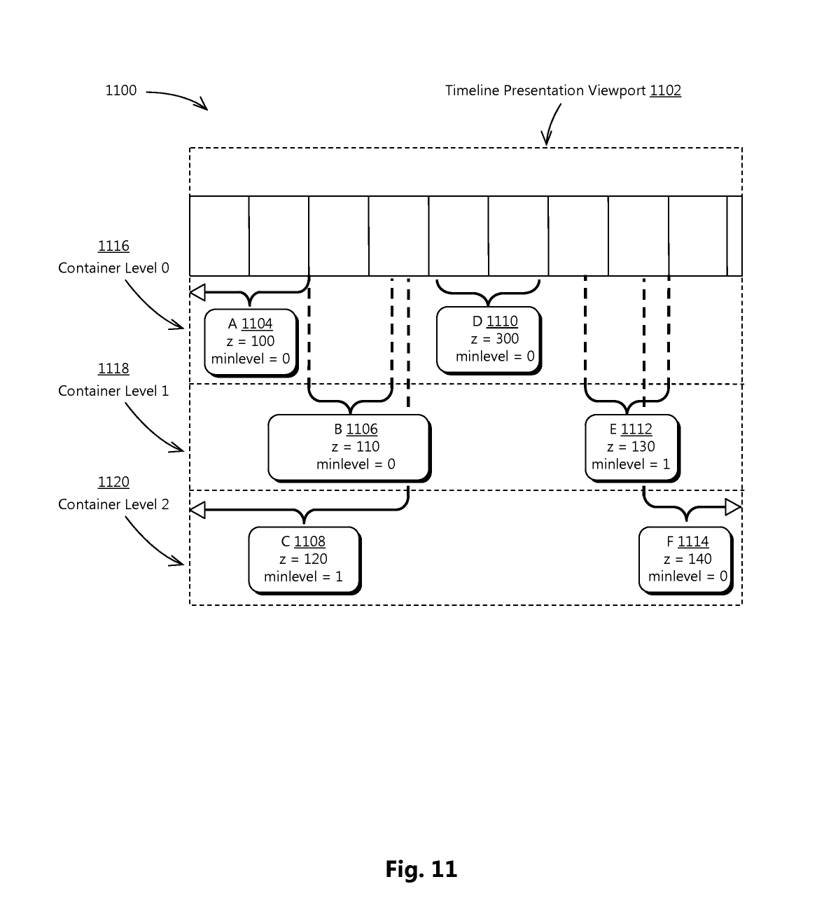

Each of the plurality of the views 212(1), . . . , 212(M) represents information about how the timeline content data 204 will be presented to the user via a display and what types of user interaction can be performed. Thus, the same timeline content data 204 can be presented in a plurality of ways and those ways can be expressed in a timeline data store 202. View 212(m) is usually comprised of viewport information 270, content filtering settings 272, per-view element information 274 and user interaction settings 276. It is understood that view 212(m) may also contain additional data if required by a particular implementation or embodiment. Viewport information 270 describes which time interval is to be currently presented to the user and at which scale. Also, viewport information 270 may contain visualization settings that are specific to a given view. For example, this may include a background color, a font of the labels, etc. Exact form and content of the viewport information 270 depends on the implementation or embodiment. Content filtering settings 272 describe which subset of the plurality of timeline elements 206(1) . . . 206(N) can be presented as part of a given view 212(m). For example, given view may only display timeline elements that are tagged in a certain way. The exact form of content filtering settings 272 depends on the implementation or embodiment. Per-view element information 274 may include information that is specific a view 212(m) for each of the plurality of the timeline elements 206(1) . . . 206 (N). While per-view element information 274 ultimately depends on the implementation or embodiment, some particular pre-view element information and its use are discussed in relation to FIGS. 11-13. User interaction settings 276 specify which user interactions are allowed in the context of a specified view 212(m). For example, some views may be read-only and only allow browsing the timeline data but not modify it. Other views may, for example, restrict the range of dates which can be presented, etc. Exact form and content of user interaction settings 276 depends on the implementation or embodiment.

FIG. 3 is a high level block diagram of an exemplary system 300 implemented in software which includes an application 310 which may correspond to one of the plurality of the applications 104(1) . . . 104(N) of FIG. 1. Application 310 may embody a timeline visualization and interaction system 312 which includes methods capable of providing timeline visualization and interaction services to an application 310. It is understood that other implementations and embodiments of a timeline visualization and interaction system may exist and given example is not intended to limit the scope. In the illustrated example timeline interaction and visualization system 312 is configured to communicate with a timeline data store 302 and obtain timeline elements 320 from timeline content data 306.

System 312 is further configured to comprise a plurality of timeline presentation contexts 316(1) . . . 316(M). Each of a plurality of presentation contexts 316(1), . . . , 316(M) may be configured to obtain view data 322 and provide visualization 318(m) for one of the plurality of views 316(1), . . . , 316(N) on one or more of the display output devices 332.

System 312 can also be configured to receive user input 328 using one or more of the input devices 330 and use this input to make updates 324 to the timeline content data 306 as well make changes 326 to a plurality of views 316(1) . . . 316(N) and thus change visualization parameters for those views. The exact logic and data maintained by a timeline presentation context depends on an implementation or embodiment. For example, typical timeline visualization and interaction system may provide services like scrolling, zoom, editing of timeline elements, and allowing user to control some specifics of how elements are visualized in a given view.

FIG. 4 is a flow diagram depicting an exemplary method of a high-level operation of a timeline presentation context within an exemplary timeline visualization and interaction system. Objects referenced in this diagram may correspond to the objects on FIG. 3. Necessary data is read from a timeline data store (block 402). This may include reading timeline elements necessary to render timeline visualization and current view parameters.

Timeline presentation context data is then read (block 404). This may include reading temporary information maintained by the presentation context which may be necessary to render timeline visualization. For example, such data may describe user interaction state, like current date range selection, etc.

Timeline visualization is then rendered (block 406). This mean processing all the data received in steps 402 and 404 and generating appropriate representation which can be consumed by the output device. For example, this may include creating pixel representation to be consumed by a computer display device.

The method then waits for at least one of the following events to occur: user input, data store change, or context state change (block 406). User input, for example, may be a mouse event or a gesture which suggests that current visualization needs to be updated. Data store change, for example, may indicate that a new timeline element has been added by a different application and thus current visualization needs to be updated. Context change may be caused by an intrinsic context event which may require visualization update. For example, such an event may be an animation tick for a scroll animation, etc.

If there was no user input (“no” from decision block 410) then it means that it was either data store change or a context change and the method may return to block 402, read the updated data store and context data and update visualization accordingly.

If there was user input (“yes” from decision block 410) then the method checks whether timeline data store should be updated as a result of this input. For example, a user may have created a new timeline item or changed properties of an existing one. If timeline data store needs to be updated (“yes” from a decision block 412) the method proceeds to modifying timeline data store (block 418).

Then, the method waits to check if context needs update as the result of a user input. For example, user may have selected a timeline element for edit and it needs to be highlighted. If context needs to be updated (“yes” from decision block 414) the method proceeds to modify timeline presentation context (block 420).

Finally, the method checks whether exit was requested as a result of a user input. For example, use may have decided to exit the application. If exit was requested (“yes” from decision block 416) then the method ends. Otherwise (“no” from decision block 416) then return to block 402, read updated timeline data store and context and render an updated visualization.

It is understood that illustrated method is only an example and describes high-level steps. Additional steps and different ordering may be used by specific implementation or embodiment.

### General Visualization and Layout

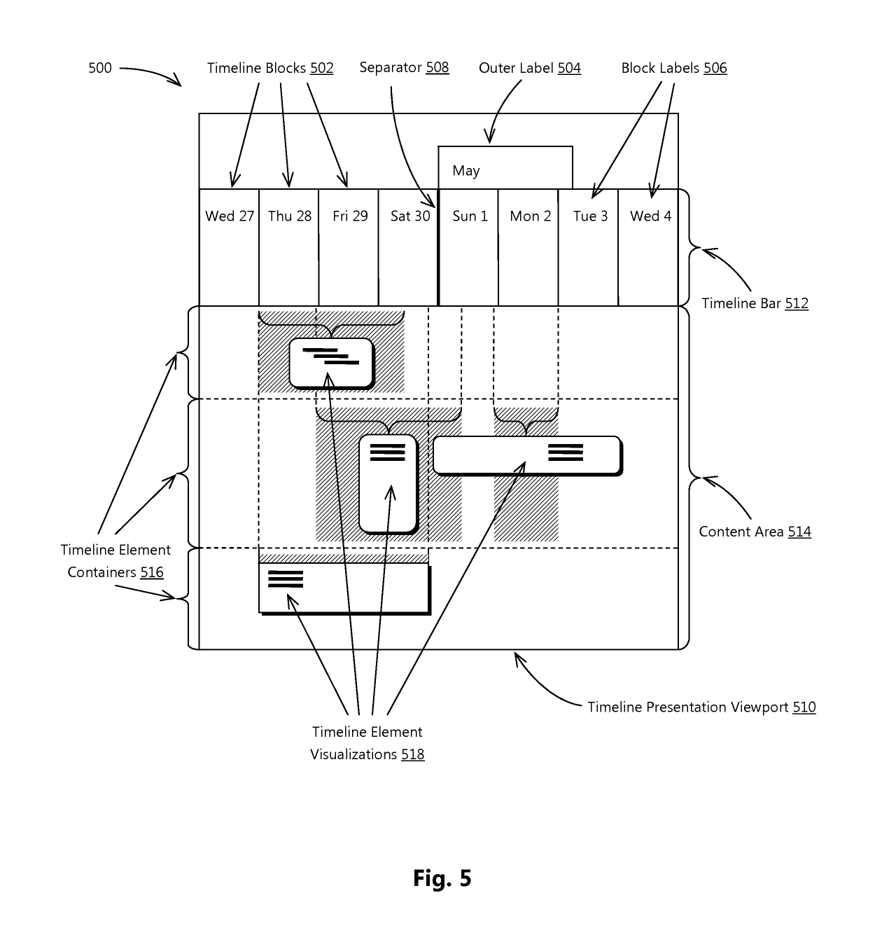

FIG. 5 illustrates an exemplary presentation layout 500 which can be used by a presentation context to render timeline visualization. It is understood that the illustrated layout is only one example and other visualizations can be made without departing the scope.

In the illustrated example, timeline visualization is rendered into a timeline presentation viewport 510, which represents area of an output device which will contain the named visualization. For example, timeline presentation viewport can be represented by a window in a windowed desktop environment.

Further, timeline presentation viewport 510 may contain a timeline bar 512, area of dedicated to present a plurality of timeline blocks 502. Each of the plurality of timeline blocks 502 represents a geometry which corresponds to a period of time. For example, in a given visualization timeline blocks may correspond to days. In a different visualization timeline blocks may correspond to months, etc. Each of the plurality of timeline blocks 502 may contain block label 506, which represents a combination of geometry and text. The exact form of block label 506 depends on implementation or embodiment. Usually block label 506 contains information about corresponding timeline block. In one embodiment it may contain text describing a day of month and a weekday. In a different embodiment it may contain text describing weekday on a background colorized differently depending on whether this is a working day or a weekend day, etc. Timeline blocks 506 rendered during visualization are usually defined by the time interval selected for presentation by viewport 510. While illustrated example presents horizontal layout of timeline blocks, in a different embodiment they may also be arranged vertically. While illustrated example shows all timeline blocks of the same type within single visualization, in a different embodiment visualization may contain timeline blocks of different types, for example days and months.

Additionally, one or more outer labels 504 may be rendered. Outer label 504 represents a combination of text or geometry usually dedicated to provide information about a group of timeline blocks. For example, outer label may contain month name in visualization where timeline blocks represent days. In a different visualization where timeline blocks represent months, outer label may contain a year number. Positioning of outer labels 504 is determined by specific implementation or embodiment as well as current viewport and visualization parameters.

Also, one or more separators 508 may be rendered. Separator 508 represents a geometry which may be rendered along with timeline blocks. For example, separators 508 may be used to visualize groupings of timeline blocks, similar to outer labels 504. Depending on an embodiment and particular visualization, groupings visualized by separators and outer labels may or may not correspond to each other.

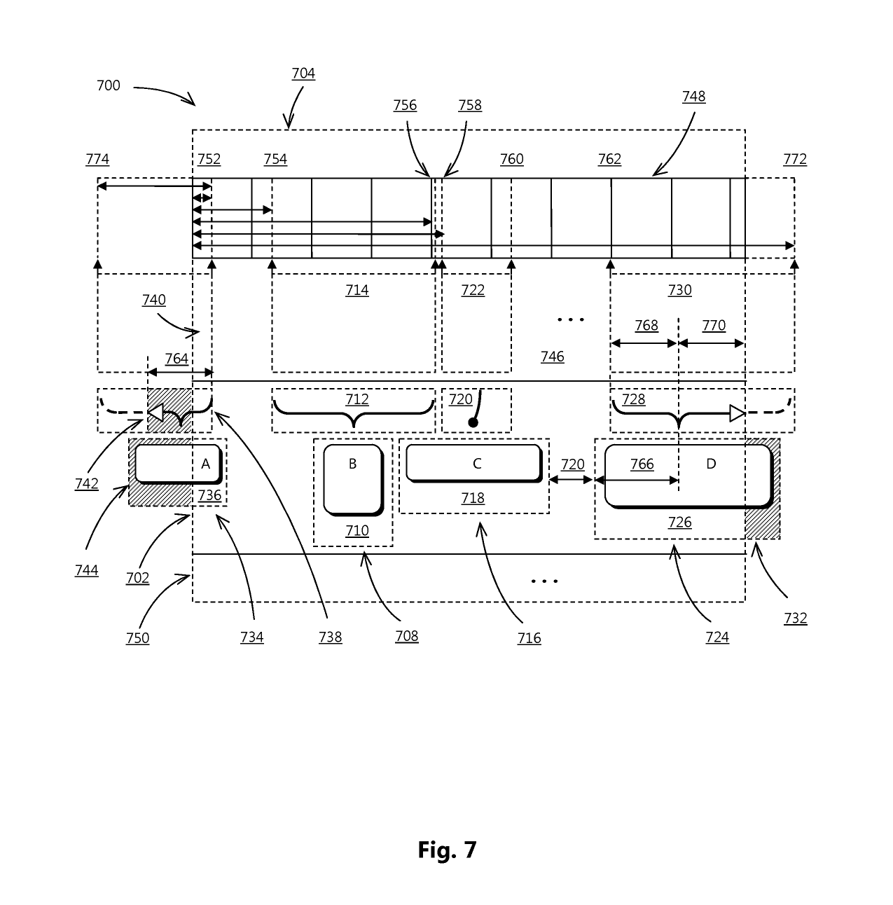

Further, timeline presentation viewport may contain content area 514 which is used to visualize timeline elements. Content area 514 may contain a plurality of timeline element containers 516. Each timeline element container 516 represents a logical sub-area of a content area 514 which is used to present a plurality of timeline element visualizations 518. Timeline element containers and layout of timeline element visualizations are discussed in detail in relation to FIGS. 7-14.

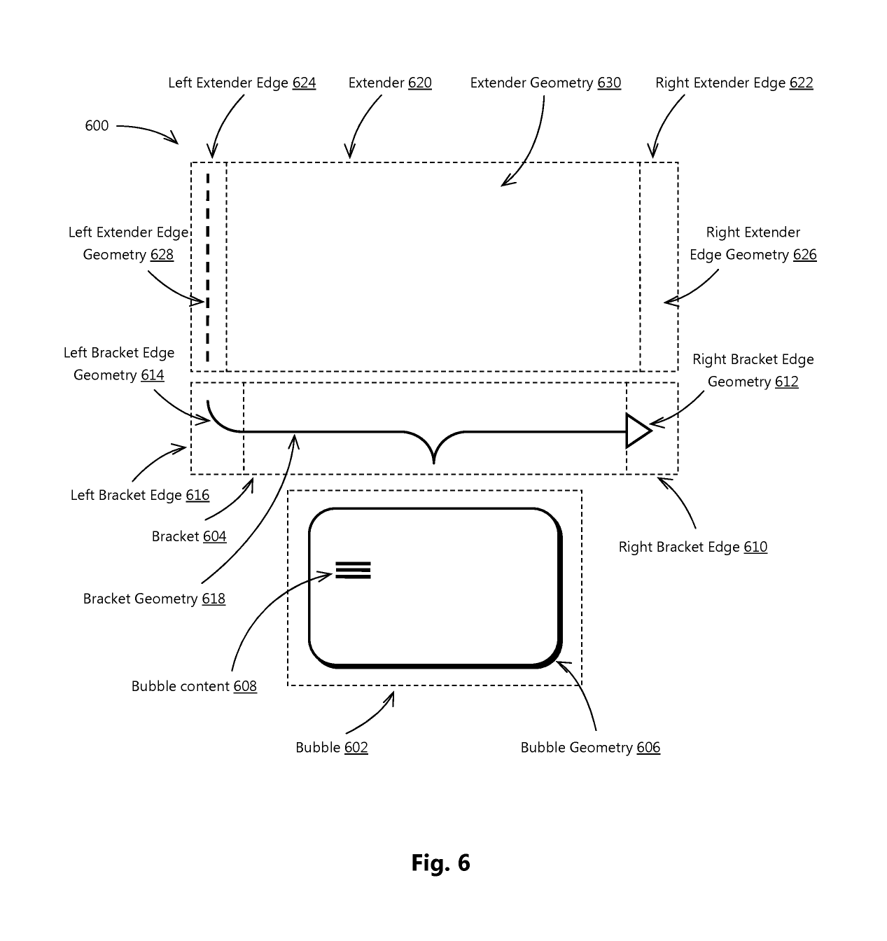

Timeline element visualization 518 may be a combination of text, geometries, and images and provides means of presenting timeline element to a user. Actual form of timeline element visualization depends on implementation or embodiment. Timeline element visualizations are discussed in detail in relation to FIG. 6. In the further discussion the terms ‘timeline element’ or simply ‘element’ may be used to refer to a timeline element visualization in context.

### Timeline Element Visualization

FIG. 6 illustrates an exemplary layout 600 of the timeline element visualization which may correspond to a timeline element 206(n) discussed in relation to FIG. 2. Layout 600 may have three components each occupying its own area: bubble 602, bracket 604 and extender 620. It is understood that components which may be present in layout 600 are not limited by the ones illustrated here and that depending on the implementation or embodiment layout 600 may also include additional components if so required. In the illustrated layout 600 areas occupied by a bubble 602, bracket 604 and extender 620 are shown as non-overlapping and arranged vertically from bottom to top respectively, but other embodiments and implementations allow for overlapping of those areas as well as different spatial arrangements. Those arrangements are discussed in more detail in relation to FIGS. 7-10.

Bubble 602 is usually comprised of bubble geometry 606 and bubble content 608 but in a different implementation or embodiment it may also include other components. Bubble content 608 may be a combination of geometry, images and text and may represent a visualization of timeline element's user-defined data 248 discussed in relation to FIG. 2. In addition to element's user-defined data 248 bubble content 608 may display other information, for example a representation of timeline element's placement in time 240, 242 and 244 discussed in relation to FIG. 2. Bubble geometry 608 represents part of visual styling for a bubble and may be defined by timeline element's style information 246 discussed in relation to FIG. 2. Layout and size of bubble content 608 and bubble geometry 606 and as a result area occupied by bubble 602 may depend on implementation or embodiment as well as style information 246, user-defined data 248 and placement within presentation layout 500 discussed in relation to FIG. 5. For example, in one embodiment bubble 602 and its components may be sized to display all of the element's text and at the same time not to exceed a pre-defined width. In a different embodiment, width of a bubble 602 may be affected by a width of other components of layout 600.

Bracket 604 may represent a visualization of timeline element's placement in time 240, 242, and 244 and may be comprised of bracket geometry 618, bracket edges 610 and 616 and bracket edge geometries 612 and 614. Bracket 604 and its components are usually sized to reflect element's placement in time 240, 242, and 244 which may relate to a corresponding placement of timeline blocks 502 discussed in relation to FIG. 5. This is discussed in more detail in relation to FIGS. 7-10. Geometries 612, 614, and 618 may depend on implementation or embodiment as well as style information 246 and placement within presentation layout 500. For example, as illustrated, bracket edge geometry 612 may be different from bracket edge geometry 614 if element's visualization is adjacent to the edge of timeline presentation viewport 510 discussed in relation to FIG. 5.

Extender 620 may be used to accent a visualization of timeline element's temporal placement 240, 242, and 244 and illustrate connection to timeline blocks 502. Extender 620 may be comprised of extender geometry 630, extender edges 622 and 624 extender edge geometries 626 and 628. As with bracket 604, extender 620 and its components are usually sized to reflect element's temporal placement 240, 242 and 244 which may relate to a corresponding placement of timeline blocks 502. This is discussed in more detail in relation to FIGS. 7-10. Geometries 630, 626, and 628 may depend on implementation or embodiment as well as style information 246 and placement within presentation layout 500. For example, as illustrated, geometry 628 may be a dashed line which extends toward timeline blocks while geometry 626 may be empty since right edge of visualization 600 is adjacent to the edge of viewport 510.

A method may be embodied in a timeline interaction and visualization system 312 discussed in relation to FIG. 3 which may consume required parameters and generate visualization layout 600. Methods and methods for deriving those parameters from a timeline data store 202 discussed in relation to FIG. 2 are described in more detail in relation to FIGS. 7-10.

### Layout of Timeline Elements in a Container

FIG. 7 illustrates an exemplary layout 700 of timeline element visualizations A 734, B 708, C 716, and D 724 which may be further referred in this section as simply timeline elements within a timeline element container 702. It is understood that illustrated plurality of elements is exemplary and different combinations of elements may appear in different embodiments without departing from the scope. As was discussed in relation to FIG. 5, presentation layout 500 may contain a plurality of timeline element containers 516 which may be stacked in sequential order to comprise content area 514. Said container 702 may correspond to one of containers 516. Area 746 may represent those containers from a plurality 516 which appear before container 702 in said sequential order while area 750 may represent those containers from a plurality 516 which appear after container 702 in said sequential order.

As was discussed in relation to FIG. 5, a timeline element container 516 may contain a plurality of timeline element visualizations 518. Elements A 734, B 708, C 716, and D 724 in the illustrated example may correspond to such visualizations 518. Element A 734 may be comprised of bubble area 736, bracket area 738 and extender area 740. Element B 708 may be comprised of bubble area 710, bracket area 712 and extender area 714. Element C 716 may be comprised of bubble area 718, bracket area 720 and extender area 722. Element D 724 may be comprised of bubble area 726, bracket area 728 and extender area 730.

In order for a plurality of timeline element visualizations A 734, B 708, C 716, and D 724 to be able to appear in the same container 702, the following conditions may be met. Bracket areas 738, 712, 720, and 728 should not overlap with each other. Bubble areas 736, 710, 718, and 726 should not overlap with each other. Bracket area for any element from a plurality A 734, B 708, C 716, D 724 may only intersect bubble area from that same element but not from different elements.

Further, offsets within container 702 have association with time. In the illustrated example different horizontal offsets within container 702 correspond to different time values, with larger offsets from the left edge of the container corresponding to larger time values. It is understood that in different embodiments said association with time may have different characteristics and may also be vertical and/or direction of time may be different. In the illustrated example association with time also corresponds to a positioning of timeline blocks within a timeline bar 748.

Using said association with time for each of the plurality of elements A 734, B 708, C 716, and D 724 a pair of offset values may be derived which will be referred to as desired bracket offsets. Those values are the offsets within container 702 which correspond to start date/time 242 and end date/time 244 of an element discussed in relation to FIG. 2. Said offsets would define logical placement and sizing for bracket areas 738, 712, 720, and 728 in an infinite container taking only temporal properties of an element into account and not applying restrictions introduced by a viewport 704 or other elements. In the illustrated example timeline elements have horizontal layout and desired bracket offsets are horizontal logical offsets relative to the left edge of container 702. For element A 734 desired bracket offsets are offsets 774 and 752 respectively. For element B 708 desired bracket offsets are offsets 754 and 756 respectively. For element C 718 desired bracket offsets are offsets 758 and 760 respectively. For element D 724 desired bracket offsets are offsets 762 and 772 respectively. Desired bracket offsets for an element define what would be referred to as desired bracket interval for an element. Desired bracket offsets and interval are subject to a minimal bracket width restriction. If desired bracket interval for an element is less than a certain value which depends on implementation or embodiment, desired bracket offsets are pushed out relative to a center of a desired bracket interval so they can accommodate minimal bracket width. In an illustrated example element C 716 is not a span and only associated with a single point in time, therefore its desired interval would be zero and would not be able to accommodate corresponding bracket geometry, so interval is expanded to minimal a bracket width and corresponding offsets 758 and 760.

Further, using calculated desired bracket offsets for each of the plurality of elements A 734, B 708, C 716, and D 724 a different pair of offset values may be derived which will be referred to as desired bubble offsets. Said offsets would define logical placement and sizing for bubble areas 736, 710, 718 and 726 in an infinite container considering only desired bracket offsets and bubble properties without applying any layout restrictions. Exact method for calculating desired bubble offsets depends on an implementation or embodiment. In the illustrated example desired bubble offsets for each element from the plurality A 734, B 708, C 716, and D 724 are calculated such that bubble area has pre-defined width and center of a bubble area would be aligned with the center of a desired bracket interval for that said element. In a different embodiment, desired bubble offsets may be always equal to desired bracket offsets, for example. Desired bubble offsets for an element define what would be referred to as desired bubble interval for an element.

Thus, the following assumptions can be made about a plurality of elements A 734, B 708, C 716, and D 724 which may appear in the same container 702. Said elements which appear in container 702 are arranged in sequential order and sorted by element's start date/time 242 as discussed in relation to FIG. 2. Desired bracket intervals for said elements do not overlap with each other and also desired bubble intervals for those elements do not overlap with each other. Elements are placed into a container by a different method, which is discussed in relation to FIGS. 11-14 and which ensures that said assumptions are met.

Elements B 708 and C 716, whose desired bracket offsets are fully contained within a presentation viewport 704, may be positioned directly using their desired bracket and bubble offsets. Extenders 714 and 722 may be also be positioned according to desired bracket intervals for those said elements in area 746 occupied by different element containers. Said extenders may be rendered so that they appear behind the content of the containers in area 746.

For element D 724 the desired bracket interval extends beyond the edge of a viewport 704 and thus a bracket area 728 for that said element should be sized to fit the viewport 704. In the illustrated example its left edge will be aligned with left desired bracket offset for the element and its right edge will be aligned with the edge of the viewport. Bracket geometries may be modified as well and those modifications depend on implementation or embodiment. In the illustrated example bracket geometry is compressed and right bracket edge geometry is changed to an arrow to visually reflect the extension beyond the edge of a viewport.

Further, bubble area 726 may be positioned differently than it is defined by desired bubble offsets for element D 724. In the illustrated example, instead of a bubble area center being aligned with a center of desired bracket interval said bubble area center is aligned with a center of bracket area 728, intervals 768 and 770 being equal. Area 732 is clipped out. It is understood that this is an exemplary bubble area placement adjustment, other implementations or embodiments may use different placement.

Extender area 730 may be positioned according to the offsets of a bracket area 728. Extender geometries may be modified to reflect the extension beyond the edge of a viewport.

For element A 734 the desired bracket interval also extends beyond the edge of a viewport 704 and thus a bracket area 738 for that said element may also be sized to fit the viewport 704. However, width of a bracket area 738 is less than a minimal bracket width 764 which can accommodate reasonable bracket geometry. Thus, minimal bracket width 764 will be used for bracket visualization, and said visualization will be rendered with an offset equal to a difference between right desired bracket offset for element A 734 and minimal bracket width 764. Area 742 will be clipped out.

In the illustrated example bubble area 736 will be centered along with a center of minimal width bracket visualization. Area 744 will be clipped out.

Extender area 740 may be positioned according to the offsets of a bracket area 738. Extender geometries may be modified to reflect the extension beyond the edge of a viewport.

It is further understood that bubble area position adjustments, due to the extension of desired bracket interval beyond viewport edges, may lead to a situation when bubble areas of elements will start overlapping even when their respective desired bubble intervals do not overlap. In the illustrated example, when scrolling timeline in a viewport from left to right and producing corresponding visualization layouts distance 720 will be shrinking and so will be distance 766.

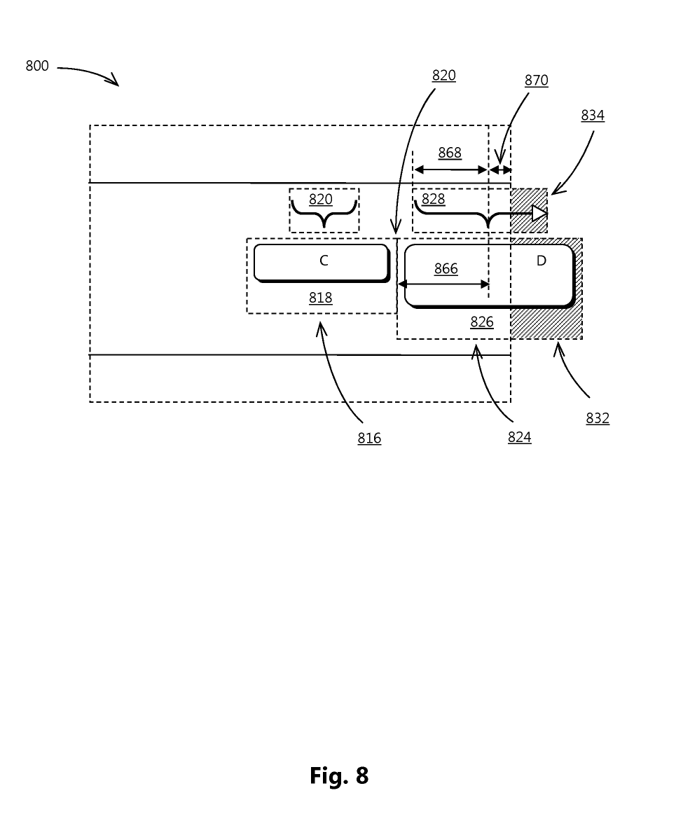

FIG. 8 illustrates an exemplary layout 800 which may represent a portion of layout 700 discussed in relation to FIG. 7 with different viewport positioning. In the illustrated example distance 720 discussed in relation to FIG. 7 and which corresponds to distance 820 has now become zero. To avoid intersections between bubble areas 818 and 826 the following approach may be utilized. Bracket area 828 may be considered to have reached its minimal width the moment distance 720 (corresponding distance 820) has reached zero, and bracket visualization rendered at this size is no longer being compressed but being offset beyond viewport edge. This layout process is similar to one for element A 734 discussed in relation to FIG. 7 but potentially with a different value used as a minimal bracket width. In the illustrated example bubble area 826 is centered along the center of bracket visualization. In the illustrated example, distances 868 and 870 are not the same. Distance 866 will remain fixed as long as distance 820 is zero. Areas 832 and 834 are clipped out.

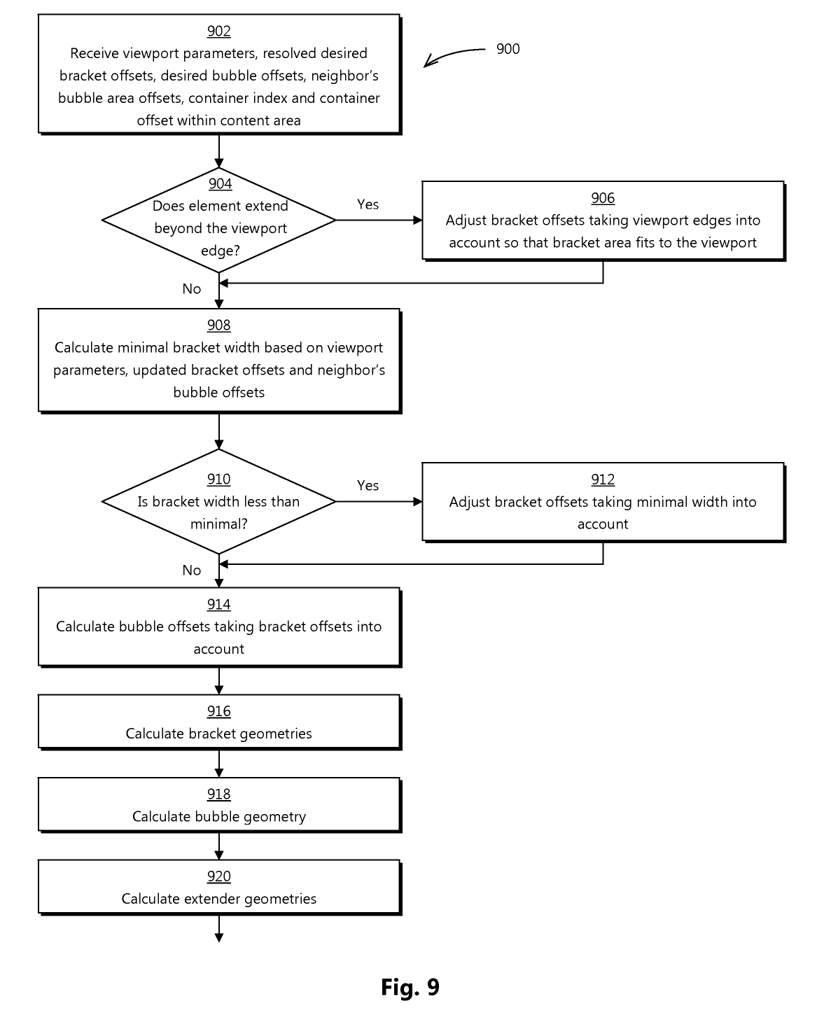

FIG. 9 is a flow diagram depicting an exemplary method 900 for a layout of timeline element visualization within a timeline element container. Viewport parameters, resolved desired bracket offsets, resolved desired bubble offsets, neighbor's bubble area offsets, container index and container offset within content area are received (block 902). Resolving desired bracket offsets depends on time association for container 702 discussed in relation to FIG. 7. It depends on implementation or embodiment. Also, resolving desired bubble offsets depends on implementation or embodiment as well as style of element and other parameters. This method 900 ensures that if given element's desired bracket interval extends beyond the edge of a viewport, its neighbor element from the other side is already positioned and its bubble area offsets are calculated and passed to this method.

If element's desired bracket interval extends beyond the edge of a viewport (“yes” from a decision block 904) then bracket area offsets need to be adjusted so that bracket area fits to the viewport (block 906).

Minimal bracket width is then calculated for this element (block 908). Viewport parameters, updated bracket offsets and neighbor's bubble edges taken into account. If current element extends beyond viewport edge and its bracket area being compressed from the desired width and neighbor's bubble would overlap this element's bubble due to this compression as it happens for elements C 816 and D 824 discussed in relation to FIG. 8 then minimal bracket width may be extended. For example, as illustrated on FIG. 8. It may be set to width 868 times 2.

If current bracket width defined by bracket offsets calculated in blocks 902 and 906 is less than minimal width calculated in block 908 (“yes” from decision block 910) then bracket offsets are adjusted to take minimal width into account (block 912). This adjustment may be different depending on implementation or embodiment. For example, if bracket does not extend beyond the edge and current bracket width is less than minimal, offsets may be pushed out symmetrically from the center of the bracket interval to accommodate minimal width and corresponding geometry. If bracket extends beyond the edge of a viewport, then one offset which falls within the viewport is left unmodified, and another offset is pushed out to accommodate minimal bracket width as it is done for element 824 discussed in relation to FIG. 8.

Bubble offsets are then calculated (block 914). This calculation takes bracket offsets calculated in previous blocks of method 900 into account as well as other parameters based on implementation or embodiment. For example, in one embodiment each bubble may have its own pre-defined which depends on its content and bubble offsets are calculated such that bubble area is centered along the center of the interval defined by final bracket offsets. In a different embodiment bubble offsets may be set to match bracket offsets.

Bracket geometries are then calculated (block 916). These geometries depend on implementation or embodiment as well as element style, view parameters etc. When calculating geometries, information about bracket offsets and whether element extends beyond viewport edge is taken into account.

Bubble geometry is then generated (block 918). Again, this geometry depends on implementation or embodiment as well as element style, view parameters etc. When calculating geometries, information about bubble offsets and whether element extends beyond viewport edge is taken into account.

Extender geometry is then generated (block 920). Again, these geometries depend on implementation or embodiment as well as element style, view parameters etc. When calculating geometries, information about brackets offsets, container offset and whether element extends beyond viewport edge is taken into account. Also, usually extender geometries are only generated for elements within a container having container index >0.

Further generated geometries may be handed off to graphics composition and rendering system for display on an output device.

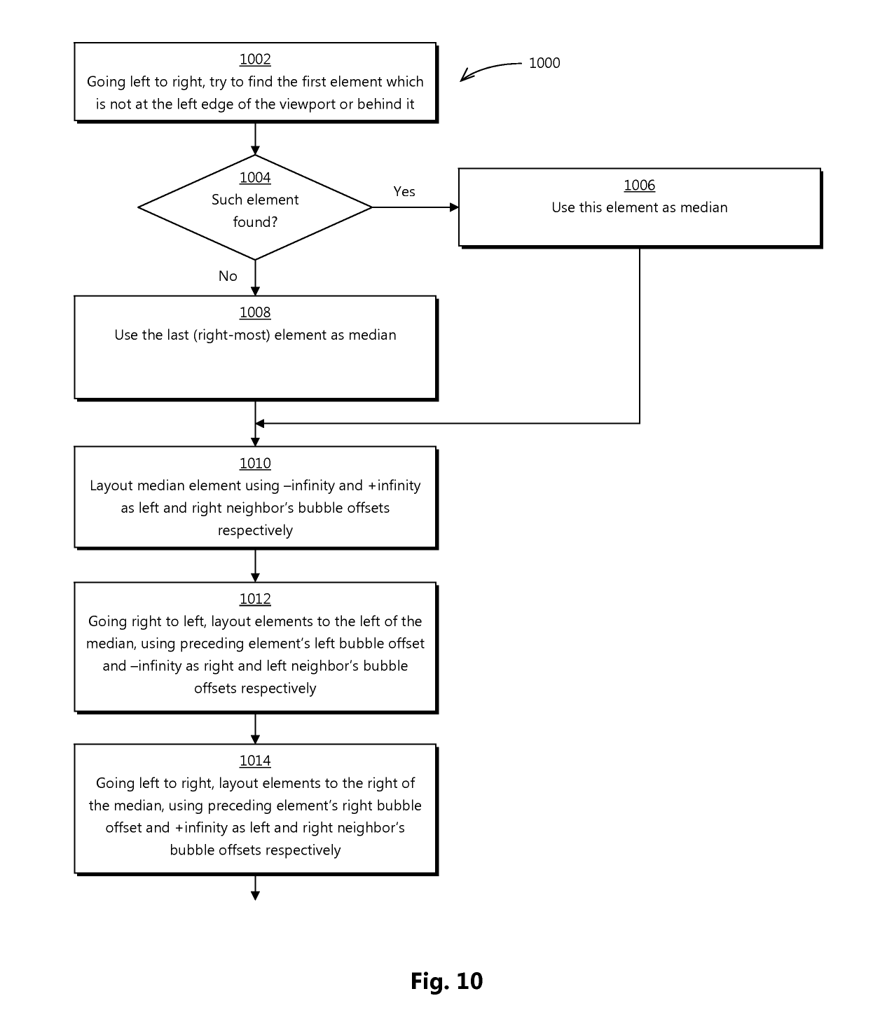

FIG. 10 is a flow diagram depicting an exemplary method 1000 for sequencing element layout within a container and ensuring that all necessary parameters are passed to a layout method 900. In this exemplary implementation horizontal layout of elements is discussed, however it is understood that the same approach may be utilized for vertical layout with small modifications. As it was mentioned in relation to FIG. 7 elements within a container appear in a sequential order. Traversing this list from left to right, try to find first element whose desired bracket interval does not extend past left edge of the viewport (block 1002). If such element exists (“yes” from decision block 1004) then use this element as median. If such element does not exist (“no” from decision block 1004) then use the last (right-most in this exemplary implementation) element as a median.

Layout median element (block 1010) by invoking method 900 and passing −infinity (smallest value representation) as left neighbor's right bubble offset and passing +infinity (largest value representation) as right neighbor's left bubble offset. Thus, layout for a median element does not use restrictions from neighbor elements and can be placed independently.

Going right to left, layout elements to the left of a median by invoking method 900 and passing preceding element's (right neighbor's) left bubble offset and −infinity (smallest value representation) as left neighbor's right offset (block 1012).

Going left to right, layout elements to the right of a median by invoking method 900 and passing preceding element's (left neighbor's) right bubble offset and +infinity (largest value representation) as right neighbor's left offset (block 1014).

Used together methods 900 and 1000 may comprise an overall method for layout of elements within a container.

Arranging Timeline Elements between Containers

FIG. 11 illustrates an exemplary arrangement 1100 in which timeline elements A 1104, B 1106, C 1108, D 1110, E 1112, and F 1114 whose desired bracket intervals intersect with presentation viewport 1102 are arranged between timeline element containers 1116, 1118, and 1120. Containers are arranged sequentially within a container area. Further, containers are assigned a level value, which corresponds to an index within a container area. In the illustrated example container 1116 is assigned level 0, container 1118 is assigned level 1 and container 1120 is assigned level 2.

As it was discussed in relation to FIG. 7, elements for which desired bracket intervals do not overlap and desired bubble intervals do not overlap may be placed within the same element container. If either desired bracket intervals intersect or desired bubble intervals intersect, such elements should be placed in different containers.

In the illustrated example, desired bubble intervals for elements A 1104 and B 1106 intersect, therefore they may be placed in different containers. Desired bracket interval of element C 1108 intersects with desired bracket intervals of elements A 1104 and B 1106, therefore element C 1108 cannot be placed in the same container with elements A 1104 or B 1106. Desired bracket and bubble intervals of element D 1110 do not intersect with those intervals of other elements. Also, desired bracket intervals of elements E 1112 and F 1114 also intersect with each other, therefore these elements cannot be placed in the same container as well.

It is understood that only elements that are currently being visualized (ones intersecting with the viewport 1102) can be considered when arranging elements among containers, elements that are not intersecting with viewport 1102 may be excluded so to not affect the arrangement of elements. Thus, same elements displayed as part of different viewport visualization may be arranged to different containers.

It is further understood that there are multiple ways in which same elements may be arranged among containers for a given visualization and still satisfy the requirements about bracket and bubble interval intersections. Methods presented here allow deterministically arranging elements among levels for a given view as well provides an opportunity for a user to specify parameters which will change the arrangement according to user preferences. This method allows for persisting those parameters in a timeline data store so that desired arrangement will be preserved among instances of a presentation context. Further, the presented method allows specifying arrangement preferences per-view, so that same elements may have different arrangements in different views.

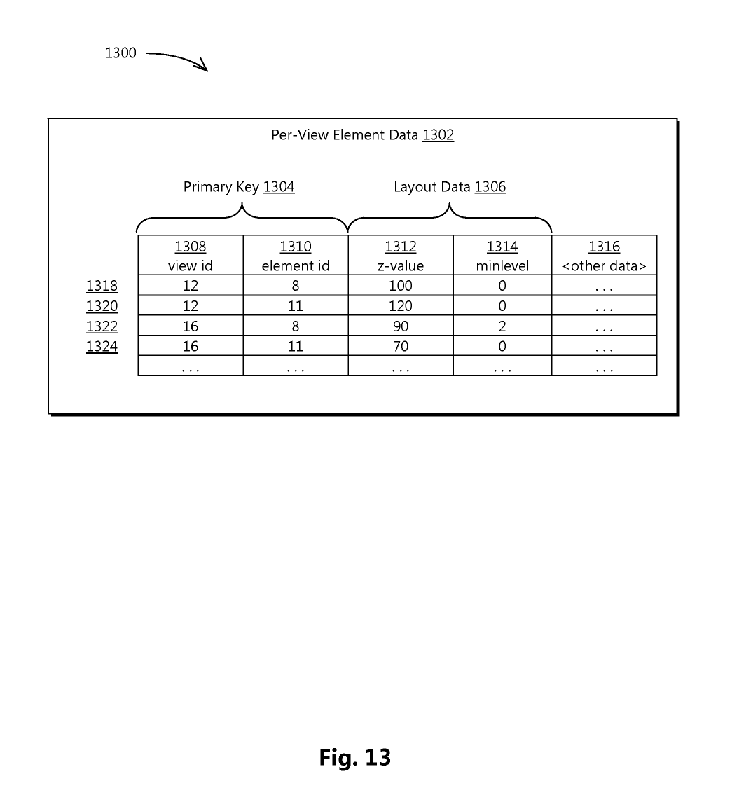

Each element which may be displayed in a view may be assigned a unique value, which will be referred to as z-value. This value is stored per element per view, so that same element may have different z-values in different views. This concept is further discussed in relation to FIG. 13. z-value may be interpreted as follows: if two elements have their desired bracket intervals or desired bubble intervals intersecting and thus need to be placed in different containers, then element with larger z-value should be placed in a container of a larger level.

Further, each element which may be displayed in a view may be assigned a value (non-unique), which will be referred to as minlevel. This value is also stored per element per view, so that same element may have different minlevel values in different views. This concept is further discussed in relation to FIG. 13. Minlevel value may be interpreted as follows: container in which such element may be placed must have level which is greater than or equal to a minlevel value of that element.

Further, respecting z-value and minlevel restrictions described in the previous two paragraphs element should be placed in a container with lowest possible level. Any number of containers necessary to satisfy the z-value and minlevel restrictions and arrange a plurality of elements that need to be visualized may be added.

Z-values and minlevel values may be initially assigned by a timeline visualization and interaction system and then may be modified by a user to change how elements are arranged in any given view.

In the illustrated example elements A 1104, B 1106, C 1108, D 1110, E 1112, and F 1114 are assigned z-values 100, 110, 120, 300, 130, and 140 respectively and minlevel values 0, 0, 0, 1, 0, 1, and 0 respectively and arranged among containers according to a method described.

Elements A 1104 and B 1106 may be placed in different levels, and since element B 1106 has larger z-value it is placed in container level 1 1118 and element A 1104 is placed in container level 0 1116. They both have minlevel=0 and, thus, can be placed in said containers. Element C 1108 has larger z-value than element B 1106 and their bracket intervals intersect, so element C 1108 is placed to a container level 3 1120. Its minlevel 1 allows for placement in container level 3 1120. Even though element D 1110 has largest z-value 300, it does not intersect any other elements in this visualization and has minlevel=0, therefore, it is placed in container level 0 1116. Element E 1112 has minlevel 1, and because of that even though there is an available slot for it in container level 0 1116 it is placed in container level 1 1118. Element F 1114 has z-value larger than z-value of element E 1112 and therefore it is placed in container level 2 1120 even though its minlevel is smaller than one of element E 1112.

As it was mentioned, same elements may be arranged to different containers in different visualizations of the same view with different viewport parameters.

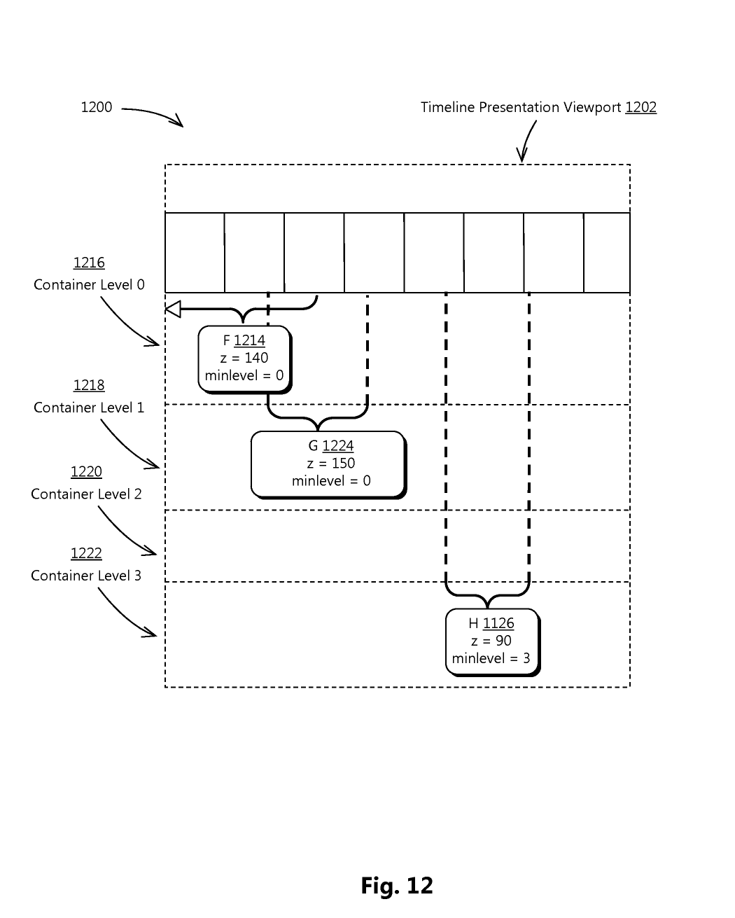

FIG. 12 illustrates an exemplary arrangement 1200 of a different visualization of the same view as one discussed in relation to FIG. 11. Viewport 1202 has different parameters from viewport 1102 and covers different time range, in the illustrated example viewport 1202 covers time interval later in time than one covered by viewport 1102.

In this visualization element F 1214 which corresponds to the same element F 1114 discussed in relation to FIG. 11 does not intersect any elements with smaller z-value in arrangement 1200 and has minlevel=0 and placed in container level 0 1216, even though element F 1114 was placed in container level 2 1120 in relation to FIG. 11.

Element G 1224 has overlapping desired bracket intervals with element F 1214 and minlevel 0 and hence placed to a container level 1 1218.

Element H 1126 has smallest z-value 90 between all discussed elements, but placed in container level 3 1222 since its minlevel is 3. Container level 2 1220 is added which remains empty in this illustrated example since this was required to arrange element H 1126.

FIG. 13 illustrates an exemplary tabular representation 1300 of per-view element data 1302 which may be stored in a timeline data store 202 as part of per-view element information 273 discussed in relation to FIG. 2. In this representation columns view ID 1308 and element ID 1310 may define primary key 1304 which identifies element data specific to a given view. Columns z-value 1312 and minlevel 1314 include per-view element layout data 1306 which was discussed in relation to FIGS. 11-12. Other data 1316 may also be stored.

In the illustrated example rows 1318 and 1320 describe per-view element information for two elements in one view while rows 1322 and 1324 describe pre-view element information for the same two elements in a different view.

It is understood that this is an exemplary data representation and other representations may be used for per-view element data without departing from the scope.

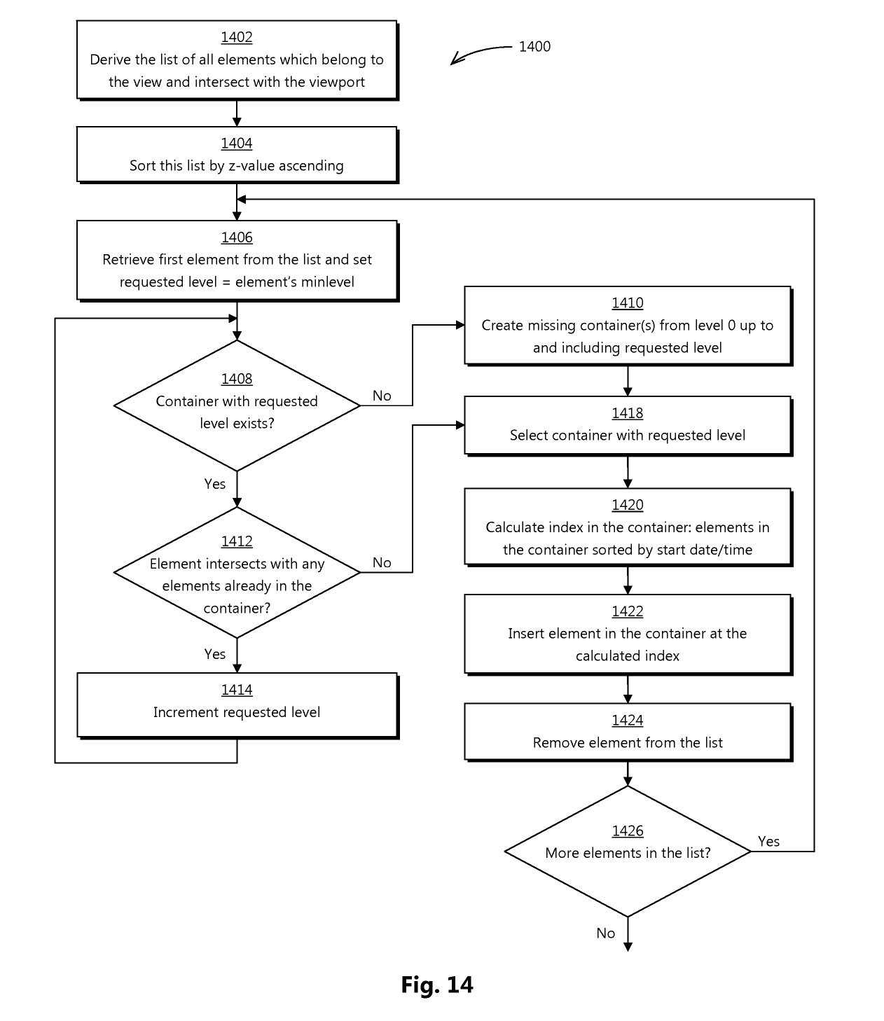

FIG. 14 is a flow diagram depicting an exemplary method 1400 for arranging timeline elements between containers. First, the list of elements which belong to a current view and intersect with the viewport is derived (block 1402). This is a plurality of elements which need to be presented as part of the current visualization and thus need to be arranged among levels.

This list is then sorted by z-value ascending (block 1404). First element is then retrieved from the sorted list and set to be current element and requested level is set to said element's minlevel (block 1406). If container with requested level does not exist (“no” from decision block 1408) then create all missing containers from level 0 up to and including the requested level (block 1410). In this case newly created container will not have any elements and ready to accommodate the new one.

If container with requested level exists (“yes” from decision block 1408) then check if any of the elements already placed within said container have desired bracket interval or desired bubble interval intersecting with those intervals of the current element. If so (“yes” from decision block 1414) considering that all elements already added to containers have smaller z-values than current element since the list of element was sorted by z-value ascending it means that current element can only be placed to a container with higher level. Increment the requested level for the current element and return to a decision block 1408. If none of the elements already placed within said container have desired bracket interval or desired bubble interval intersecting with those intervals of the current element (“no” from decision block 1412) then element can be placed in the in the container with requested level.

Container with requested level is then selected for adding current element (block 1418). This selected container does not have any elements for which desired bracket interval or desired bubble interval intersects with said intervals of the current element.

Index for the current element is then calculated (block 1420). Elements in the container should be sorted by start date/time associated with them. Index is calculated considering this requirement.

Element is then inserted to the container at the calculated index (block 1422). After that element is removed from the list of elements which need to be added to containers (block 1424). If there are more elements in that list (more elements to add to containers, “yes” from decision block 1426) then return to block 1406. Otherwise execute method 1000 for each of the containers generated by method 1400.

It is understood that method 1400 is exemplary and alternative implementations or embodiments which may include optimizations may be introduced without departing the scope.

### Visualization of Search and Filtering Results

In multiple user scenarios, it may be desired to perform a search within a plurality of timeline elements or filter said elements by a certain criteria and then display the results of this search or filtering. It is common that timeline elements which satisfy given search or filtering criteria may be spread around a long period of time. At the same time, the results need to be presented in a form which would allow a user to quickly browse through them. Methods described for presenting which timeline element search and filtering results which preserves visualization of temporal properties and allows for quick browsing of results.

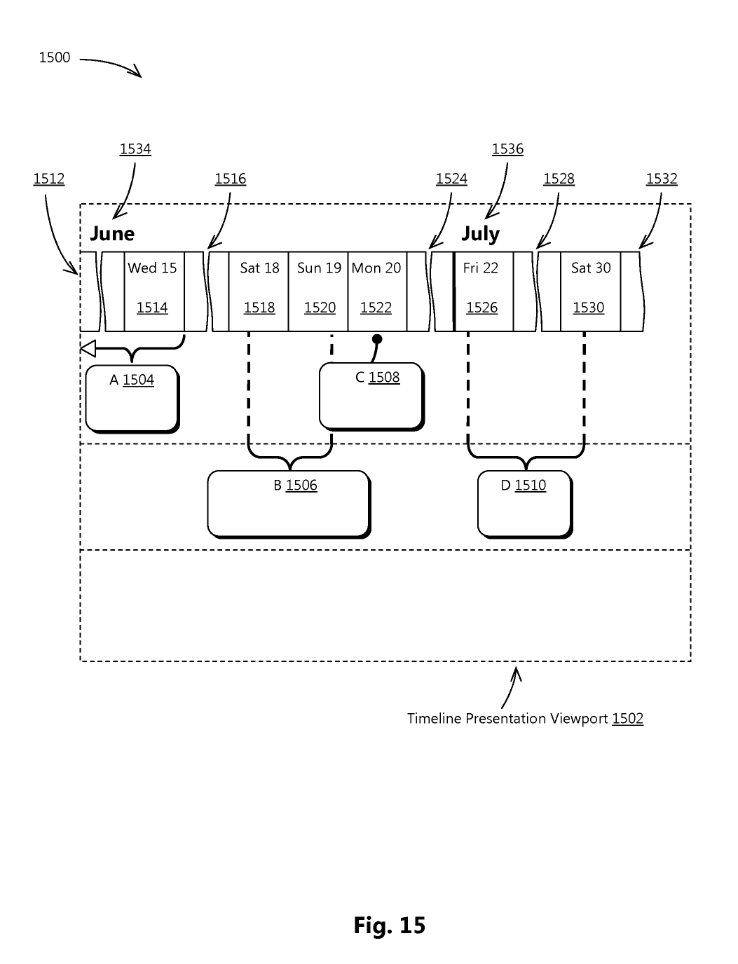

FIG. 15 illustrates an exemplary layout 1500 which displays to a viewport 1502 a plurality of timeline elements A 1504, B 1506, C 1508, and D 1510 which represent results of a search performed in a view. It is understood that this plurality is exemplary and other result sets may be visualized using presented approach without departing from the scope.

Layout 1500 embodies two types of timeline blocks. Standard ones 1514, 1518, 1520, 1522, 1526, and 1530 in the illustrated example correspond to days. It is understood that depending on the implementation or embodiment such block may correspond to other time intervals, for example months, years, etc. Unlike timeline blocks illustrated on FIG. 5, in layout 1500 said timeline standard blocks are only present if they contain start date/time or end date/time for one of the timeline elements in the result set of a search or filtering which is being presented. In the illustrated example block 1514 contains end date/time for element A 1504, blocks 1518 and 1520 respectively contain start and end date/times for B 1506, block 1522 contains both start and end date/times for C 1508 and blocks 1526 and 1530 respectively contain start and end date/times for D 1510.

If some plurality of standard timeline blocks that need to be displayed represent subsequent blocks (subsequent calendar days in the illustrated example, represented by blocks 1518, 1520, and 1522) then such blocks may be presented adjacent to each other. If standard blocks are not subsequent, special gap block is placed between them and represents the interval of time enclosed between its neighboring standard blocks. In the illustrated example there are gap blocks 1512, 1516, 1524, 1528, and 1532. Gap blocks may represent time intervals of different lengths. Depending on implementation or embodiment gap blocks may have different visualizations and sizes. In the illustrated example gap block 1532 has only one neighbor, and it represents interval of time which has start date/time and extends infinitely into the future. Similarly gap block may be present which represents interval which has end date/time and extends infinitely into the past. In the illustrated example gap block 1532 visualizes the fact that there are no more results that satisfy search or filtering criteria beyond time interval represented by block 1530.

It is further understood that gap blocks may be used not only to visualize search and filtering results, but for other purposes as well, including but not limited to scenarios where it makes sense for a user to focus on certain intervals of a timeline, for example a week around departure date and week around return date for a flight, but not in between.

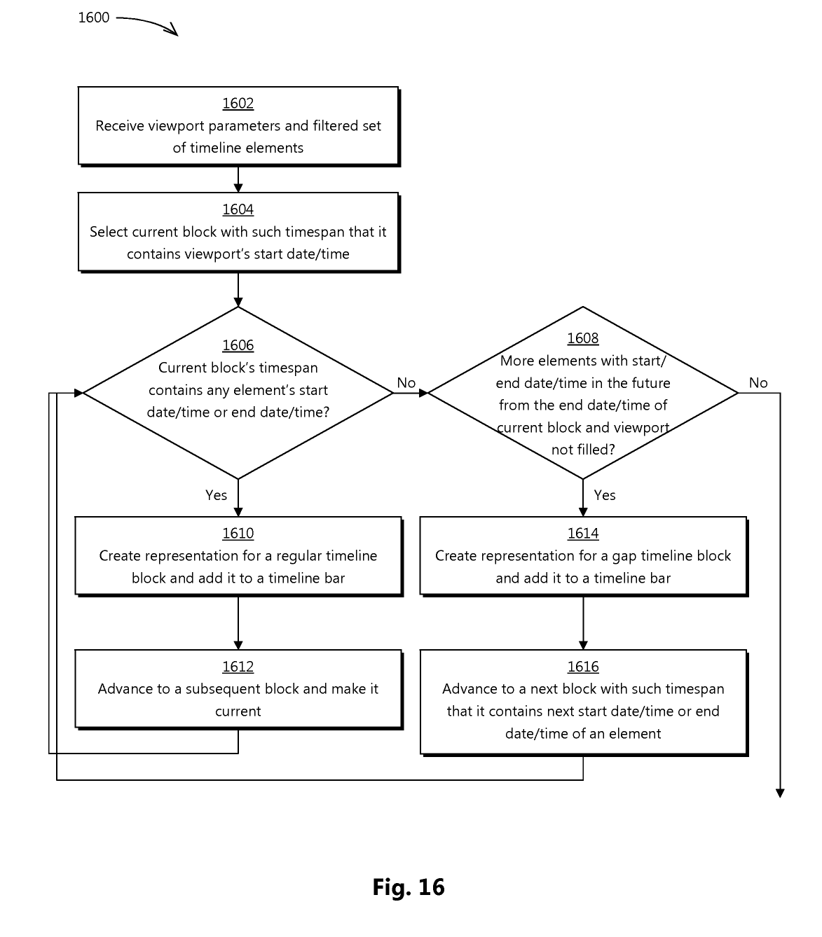

FIG. 16 is a flow diagram depicting an exemplary method 1600 for displaying timeline blocks for layout 1500 discussed in relation to FIG. 15. Viewport parameters are received (block 1602), including width, start date/time for the viewport and type of standard timeline blocks. Method 1600 described in relation to a horizontal layout discussed in relation to FIG. 15 but it is understood that approach can be applied to a vertical layout or a layout with other parameters without departing from the scope.

Timeline block is selected with such timespan so that it contains viewport's start date/time (block 1604). If timespan of a current timeline block contains start date/time or end date/time of any timeline elements in a visualized set (“yes” from decision block 1606) then create representation of a regular timeline block and add it to a timeline bar (block 1610). Then, advance to a subsequent regular timeline block and make it current (block 1612) and return to block 1606).

If timespan of a current block does not contain any element's start date/time or end date/time (“no” from decision block 1606), then see if there are more elements with start/end date/time in the future from the end date/time of a timespan of a current block and viewport is not filled (there is more space to place timeline blocks). If so (“yes” from decision block 1608) then create representation for a gap timeline block and add it to a timeline bar (block 1614). Then, advance to a next block with such timespan that it contains next start date/time or end date/time of an element (block 1616) and return to block 1606. If not (“no” from decision block 1608) then exit method.

After method 1600 is finished, may add closing gap blocks if space is left between last timeline block and right edge of a viewport and between first timeline block and left edge of a viewport.

Interaction with a Timeline

Interactions discussed in this section may be initiated by a variety of input operations. Depending on implementation or embodiment those operations may initiated using different input methods and devices. For example, a drag operation may be achieved via mouse click and move, touch screen press and move or a simulated sequence of input events. It is understood that a choices of input devices and techniques do not limit the scope.

Further, depending on implementation or embodiment, different intermediate visualizations may be employed to indicate components and stages of a UI like element selection, manipulation, intermediate state, etc. Choices of those visualizations and techniques also do not limit the scope.

### Adjusting Arrangement of Timeline Containers Between Elements

As it was discussed in relation to FIG. 11, a user may want to change an arrangement of timeline elements between containers to achieve the desired visual results when presenting a timeline. A particular method is presented for a user interface which works in conjunction with arrangement techniques discussed in relation to FIGS. 11-14 and allows changing arrangement of elements using simple and intuitive drag operations.

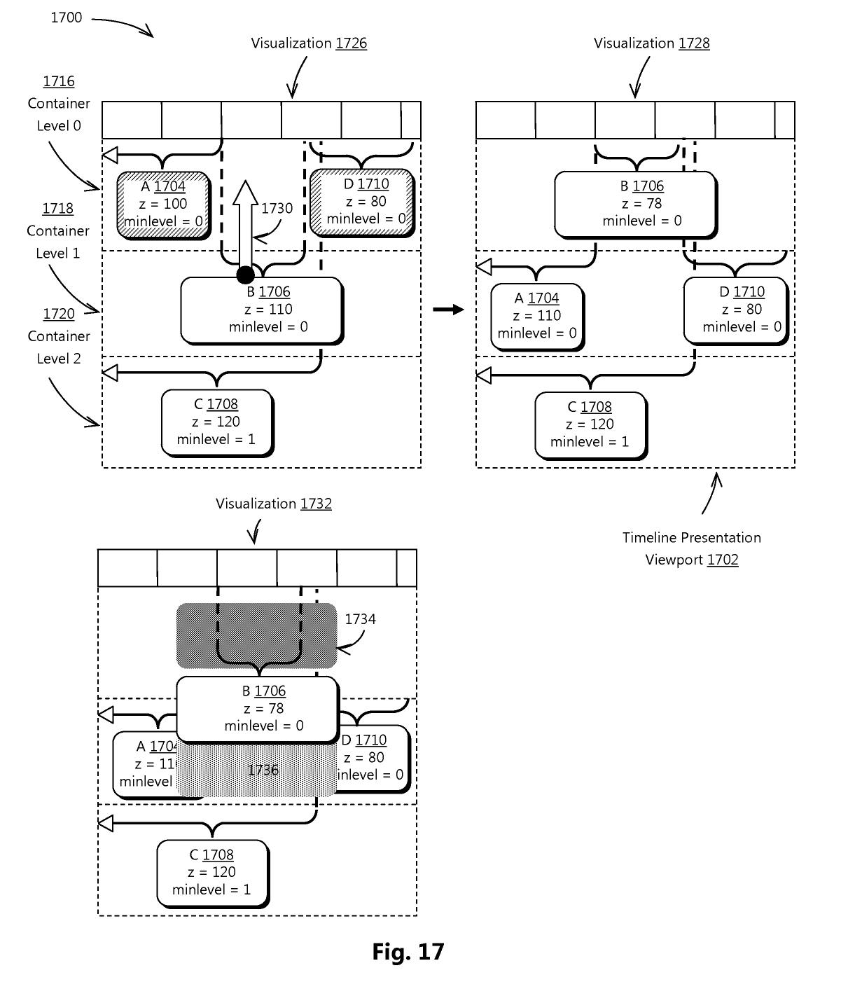

FIG. 17 illustrates an exemplary UI manipulation 1700 which allows changing mutual arrangement of timeline element B 1706 and timeline elements A 1704 and D 1710. In the illustrated example desired bubble interval of element B 1706 intersects desired bubble intervals of A 1704 and D 1710 and because of that element B 1706 needs to be placed in different container for the initial visualization 1726. According to methods discussed in relation to FIGS. 11-14 and given assignment of z-values element B 1706 is initially placed in container level 1 1718 and elements A 1704 and D 1710 are placed in container level 0 1716 for initial visualization 1726. There is also element C 1708 in container level 2 1720.

User may initiate a manipulation 1730 by selecting element B 1706 and dragging it toward area of container level 0 1716 which may be also referred to as target container. By executing this manipulation, user indicates intent for manipulated element B 1706 to appear lower in container stack than elements in a target container which intersect with manipulated element B 1706 (A 1704 and D 1710) and currently “push” it to a container of a higher level. In the illustrated layout this manipulation may be also referred to as push-down manipulation. For this manipulation, intersection means intersection of either desired bracket intervals or desired bubble intervals in the current visualization. Only elements that are displayed as part of this visualization and thus arranged among containers are considered for intersection.

If this manipulation is confirmed and executed, element B 1706 will be assigned z-value which is smaller than the min of z-values assigned to A 1704 and D 1710 but larger than any other z-value for element in this view which was previously smaller than the min of z-values assigned to A 1704 and D 1710. As a result of this z-value re-assignment and according to techniques described in relation to FIGS. 11-14, after said manipulation in a new visualization 1728, element B 1706 will be placed in container level 0 1716, elements A 1704 and D 1710 will be placed in container level 1 1718 and element C 1708 will remain in container level 2 1720. By storing new z-values in per-view element data, new arrangement will be persisted.

FIG. 17 also illustrates intermediate visualization 1732 which may be one of intermediate visualizations produced at some point during manipulation. It captures element B 1706 in an intermediate placement during drag, elements A 1704 and D 1710 already swapped to container level 1 1720 to provide user a preview of a result of manipulation as well as original area 1736 occupied by B 1706 and projected snap area 1734 for the new placement. It is understood that intermediate visualizations may be different depending on implementation or embodiment.

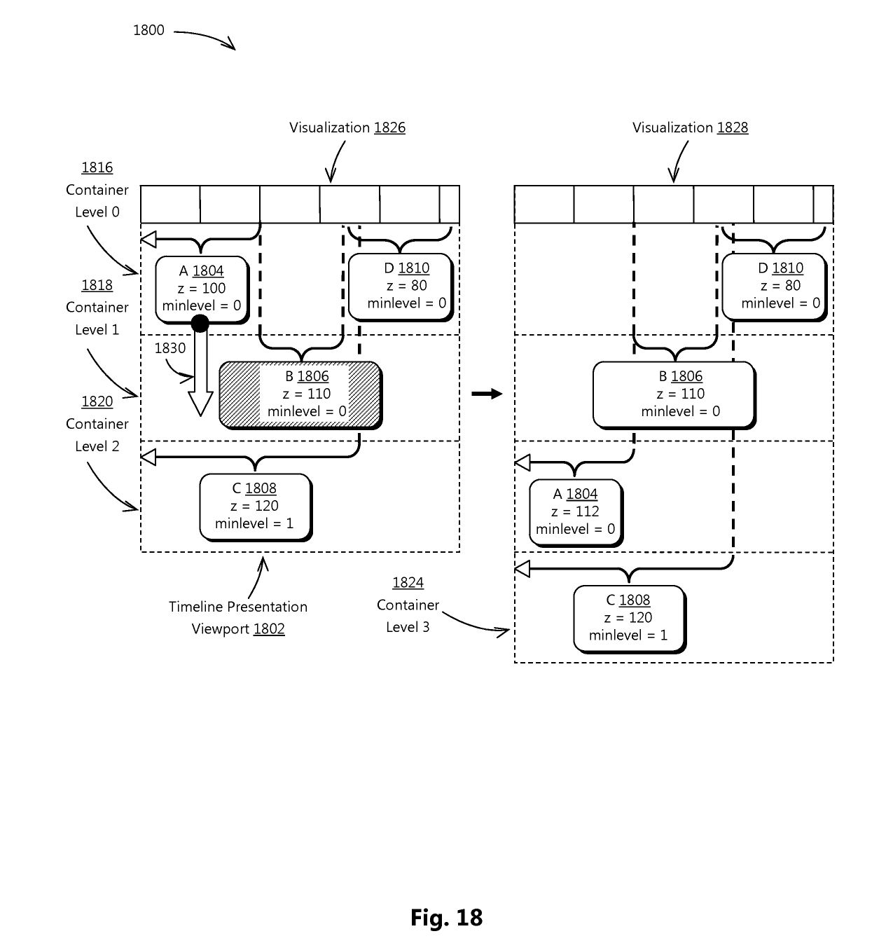

FIG. 18 illustrates an exemplary UI manipulation 1800 which allows changing mutual arrangement of timeline element A 1804 and element B 1806. In the illustrated example initial visualization 1826 is identical to visualization 1726 discussed in relation to FIG. 17. Element being manipulated in this example is A 1804 and it is being dragged toward area of target container level 1 1818. By executing this manipulation, a user indicates intent for manipulated element A 1804 to appear higher in container stack than elements in a target container which intersect with manipulated element A 1804 (B). In the illustrated layout this manipulation may be also referred to as push-up manipulation.

If this manipulation is confirmed and executed, element A 1804 will be assigned z-value which is larger than z-value assigned to B 1806 but smaller than any other z-value for element in this view which was previously larger than the z-value assigned to B 1806. As a result of this z-value re-assignment and according to techniques described in relation to FIGS. 11-14 after said manipulation in a new visualization 1828 element D 1810 will remain placed in container level 0 1716, element B A 1806 will remain in container level 1 1818, and element A 1804 will be placed in container level 2 1820 and element C 1808 will be placed in container level 3 1824. Again, by storing new z-values in per-view element data new arrangement will be persisted.

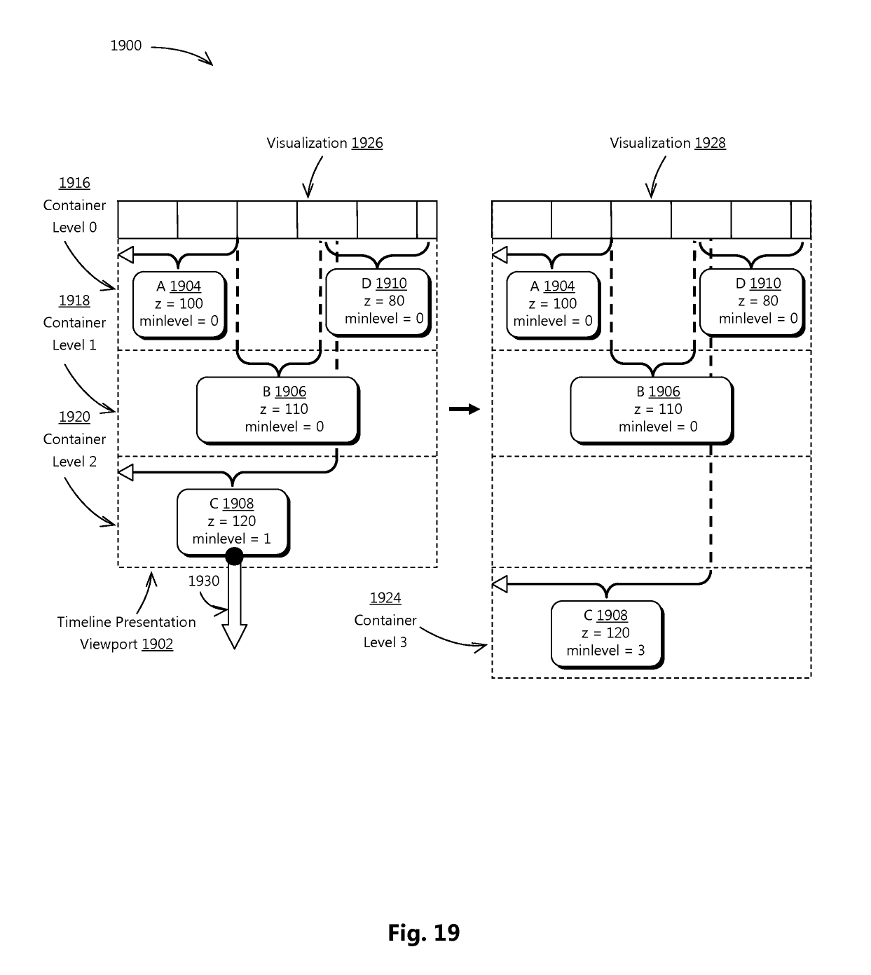

FIG. 19 illustrates an exemplary UI manipulation 1900 which allows pulling element C 1908 to appear in a container with higher level. In the illustrated example initial visualization 1926 is identical to visualization 1726 discussed in relation to FIG. 17. Element being manipulated in this example is C 1908 and it is being dragged toward area where container level 3 would be placed. By executing this manipulation, a user indicates intent for manipulated element C 1908 to appear higher in container stack than its current placement. In the illustrated layout this manipulation may be also referred to as push-up minlevel manipulation.

If this manipulation is confirmed and executed, element C 1908 will be assigned minlevel value equal to level of a container in which element C 1908 resided before manipulation plus one. In the illustrated example it will be assigned value 3. As a result of this minlevel re-assignment and according to techniques described in relation to FIGS. 11-14 after said manipulation in a new visualization 1928 element C 1908 will be placed in container level 3 1924 and other elements will remain in their original containers. By storing new minlevel value in per-view element data new arrangement will be persisted.

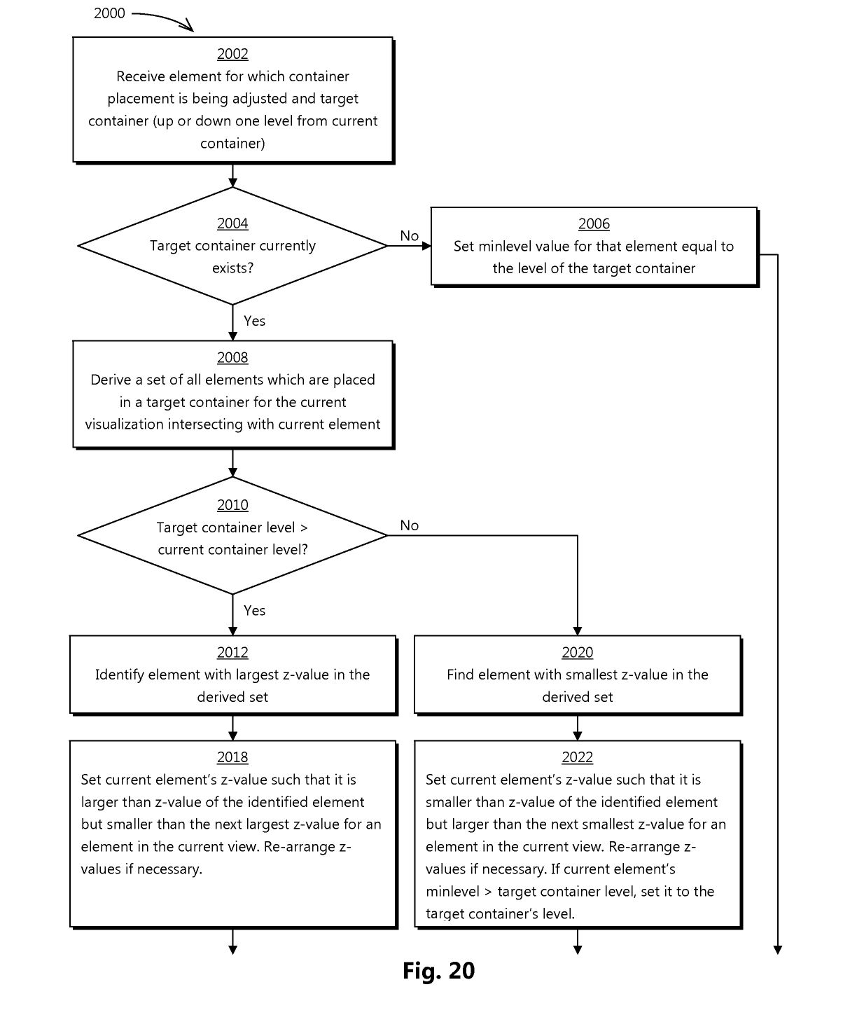

FIG. 20 is a flow diagram depicting an exemplary method 2000 for adjusting z-value and minlevel of element being manipulated using drag operations discussed in relation to FIGS. 17-19. Element selected by user for manipulation is received as well as target container level (block 2002). This information is derived from the parameters of drag operation. Method 2000 describes drag manipulation between adjacent containers (plus or minus one container level). Without departing from the scope, this approach may be repetitively applied to drag element across multiple container levels or across multiple container levels at once.

If target container with specified level does not exist (“no” from decision block 2004) then it is push-up minlevel manipulation discussed in relation to FIG. 19. Set minlevel value for manipulated element equal to the level of target container (block 2006) and exit method. If target container exists (“yes” from decision block 2004) then derive a set of all elements currently in target container for current visualization which intersect with manipulated element (block 2008). Intersection means intersection of either desired bracket intervals or desired bubble intervals.

If target container level is greater than current container level for manipulated element (“yes” from decision block 2010) then it is push-up manipulation discussed in relation to FIG. 18. Find maximum z-value for elements in a set derived in block 2008 (block 2012). Set z-value for manipulated element to be larger than maximum z-value calculated in block 2012 but smaller than the next largest z-value of element in the current view (block 2018). If, to achieve this result, changing z-values of other elements is needed, do so without changing ordering of changed z-values.

If target container level is smaller than current container level for manipulated element (“no” from decision block 2010) then it is push-down manipulation discussed in relation to FIG. 17. Find minimum z-value for elements in a set derived in block 2008 (block 2020). Set z-value for manipulated element to be smaller than minimum z-value calculated in block 2020 but larger than the next smallest z-value of element in the current view (block 2022). If, to achieve this result, changing z-values of other elements is needed, do so without changing ordering of changed z-values. If manipulated element's minlevel is larger than the target container level, set manipulated element minlevel equal to the target container level.

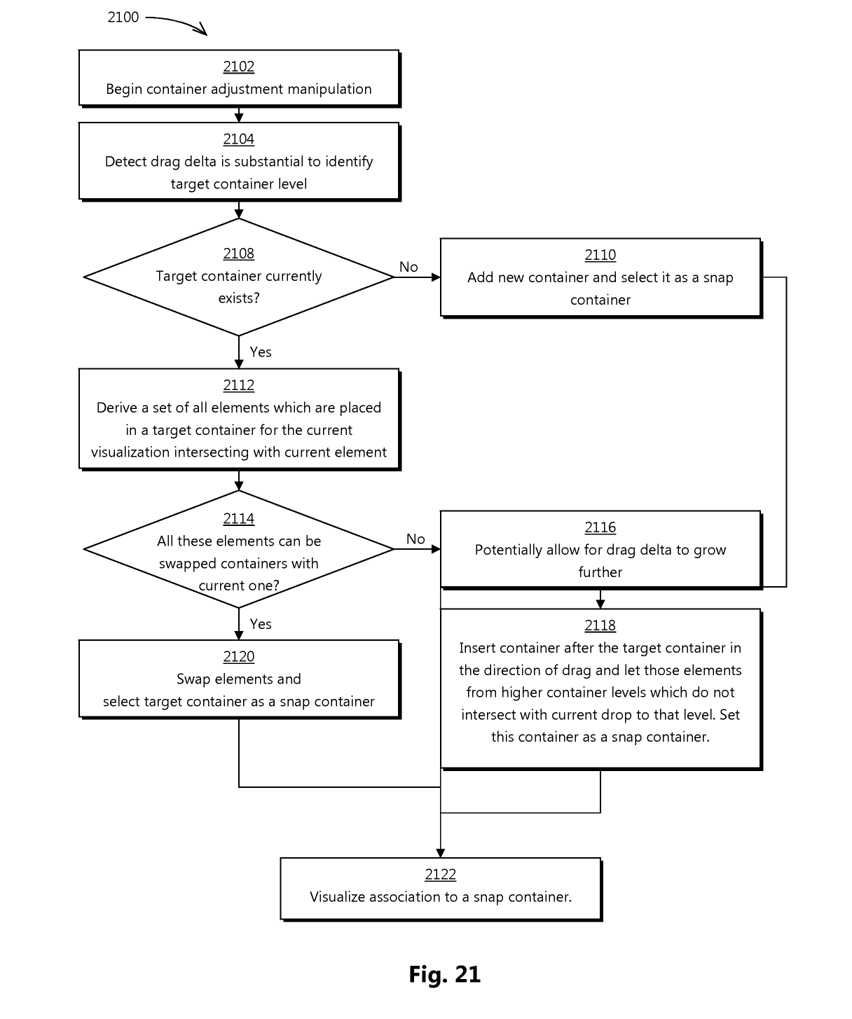

FIG. 21 is a flow diagram depicting an exemplary method 2100 for possible visualization of intermediate states of manipulations discussed in relation to FIGS. 17-20. First, begin container adjustment manipulation (block 2102). This is achieved by user selecting element for manipulation and specifying manipulation type to be container adjustment manipulation. As it was discussed, depending on implementation or embodiment, this can be achieved in different ways.

Then, detect that drag delta is used to identify target container level (block 2104). If this container level does not exist (“no” from decision block 2108) then temporarily add new container and select it as a snap container (block 2110). Then visualize association with span container (block 2122). This can be done in a variety of ways. One possible way is illustrated on FIG. 17 where symbolic geometry 1734 mimicking manipulated element's bubble is being drawn on the area of the target level, indicating potential new placement of an element.

If container already exists (“yes” from decision block 2108), then derive a set of all elements currently in target container for current visualization which intersect with manipulated element (block 2112). Intersection means intersection of either desired bracket intervals or desired bubble intervals.

If all these elements can be swapped containers with manipulated element, (meaning that they can be placed to the container of manipulated element without intersecting other elements in this container, “yes” from decision block 2114), then swap containers temporarily between manipulated element and a set of elements derived in block 2112 (block 2120). This swap may be visualized using animation if so chosen by the implementation and includes moving visualizations of elements derived in block 2112 to the container of manipulated element. Then proceed to block 2122.

If some of the elements cannot be swapped containers with manipulated element (“no” from decision block 2114), then potentially allow for drag delta to grow further until snapping can occur to provide feedback to the user that swap will not happen and element should be dragged further (block 2116). Then insert container after the target container in the direction of drag and let the elements from higher container level which do not intersect with manipulated element to drop to the new container level (block 2118). Select new container as a snap container and proceed to block 2122. If this was push-up manipulation, container is inserted at position of target container plus one. If this is push down manipulation container is inserted at position of target container minus one. In any case when container is inserted, elements that can be moved down in container level according to z-value and minlevel rules and will not interfere with manipulated element may be moved down to reflect preview of a final placement which is possible after manipulation is completed.

### Adjusting Timespan of a Timeline Element

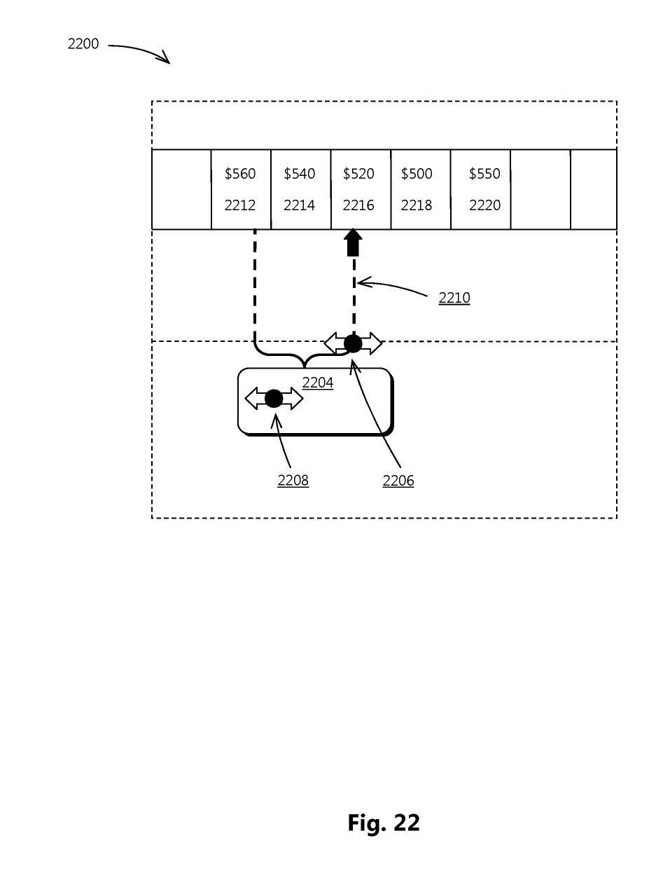

FIG. 22 illustrates an exemplary UI manipulation 2200 which allows changing timespan of a timeline element 2204. Manipulator 2206 may be invoked, for example by selecting and dragging edge of a bracket or extender in a visualization of element 2204. Adjusted position 2210 will reflect new value for element's start or end date/time. Depending on embodiment, various snapping options may be employed, for example, but not limited to snapping to the edges of timeline blocks. As manipulation progresses, visualization of element 2204 may reflect information relevant to a potential current change in timespan. For example, it may reflect the current price for the picket is given timespan selection is confirmed. In addition, once manipulation is in progress, timeline blocks may display relevant visual information and provide hint to a user regarding potential changes. For example, as illustrated, timeline blocks 2212, 2214, 2216, 2218, and 2220 may display price of a ticket if return date is selected during manipulation to be the date represented by a corresponding block.

Similarly, manipulator 2208 may be used to move the whole element in time. Manipulator 2208 may be invoked, for example, by selecting and dragging bubble area of visualization of element 2204. Again, depending on embodiment, various snapping options may be employed, for example, but not limited to snapping start and end date/times to the edges of timeline blocks. As manipulation progresses, visualization of element 2204 may reflect information relevant to a potential current change in timespan. In addition, once manipulation is in progress, timeline blocks may display relevant visual information and provide hint to a user regarding potential changes.

### Gap Block Manipulations

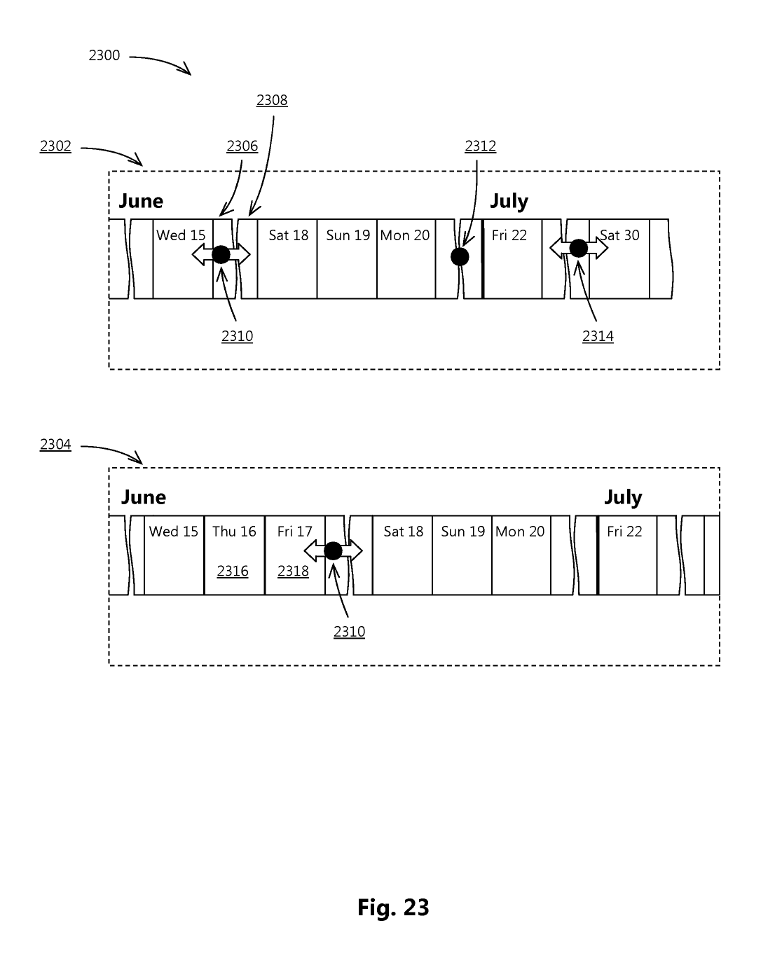

FIG. 23 illustrates exemplary UI manipulations 2300 which may be applied to gap blocks and modify their properties. First, a series of timeline blocks may be selected and option to fold then may be selected by a user. Then selected blocks will be replaced by a single gap block (folded). Information about folded regions may be persisted in the view data in a timeline data store.

Further, manipulator 2310 may be invoked, for example by selecting and dragging left part 2306 of gap block representation, to modify start/date time of a gap bock. Visualization 2304 illustrates an example of moving manipulator 2310 in original visualization 2302 in right direction and shifting start date/time of a timeline block manipulated forward by two days. To reflect this change, two new standard blocks 2316 and 2318 are added in visualization 2304 and blocks to the right of manipulated block are shifted accordingly.

Similarly, manipulator 2314 may be applied for example by dragging right part of gap block to adjust end date/time of said block.

Further, manipulator 2312 may be applied to unfold the gap block and replace it by corresponding standard blocks. Invocation of this manipulator may be implemented in a variety of ways.

### Timeline Scaling

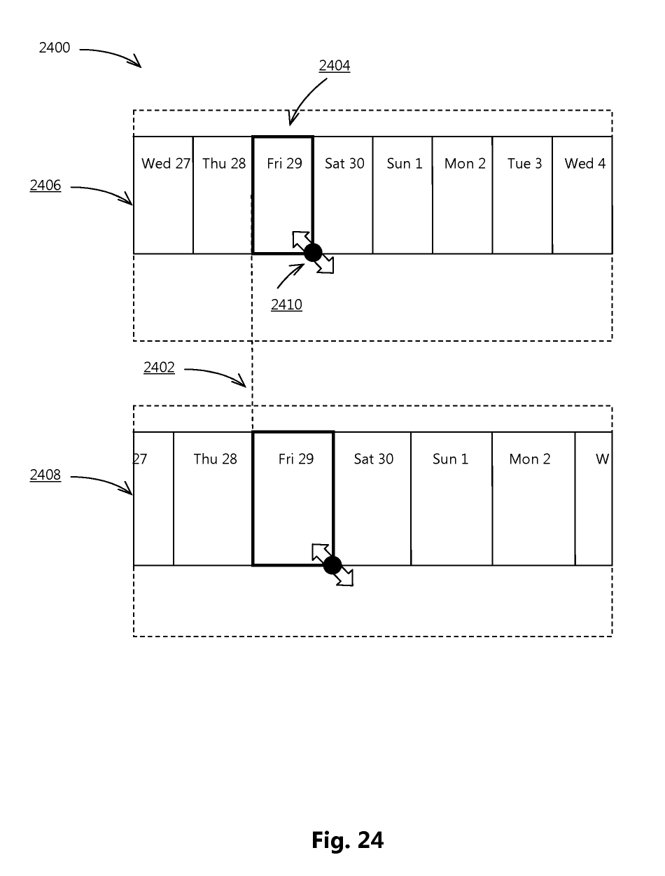

FIG. 24 illustrates exemplary UI manipulation 2400 which allows modifying scale of a timeline blocks. Manipulator 2410 may be applied, for example, by dragging a corner of a timeline block 2404. As a result of this manipulation, origin 2402 of a manipulated timeline block remains fixed, but size changes according to manipulation, and correspondingly may change sizes of other blocks in visualization. Visualization 2408 illustrates a result of applying manipulator 2410 to original visualization 2406.

### Arranging Timeline Elements Between Bands

Bands provide further means for arranging timeline elements within the content area in addition to ones discussed in relation to FIGS. 11-14 above. A band represents a group of timeline elements in a given view which may be laid out independently. One timeline element may belong to exactly one band for a given view. Band assignment information may be stored in per-view element data table 1302 discussed above in relation to FIG. 13. Each band may be given a unique identification (ID) which may be stored in one of the additional columns in the per-view element data table 1302. Band assignment may be accomplished by a user or provided by an external algorithm and, generally, does not depend on the intersection of timeline elements as it may for container arrangement discussed in relation to FIGS. 11-14. Bands for a given view are ordered and are displayed within the content area according to this order. Areas occupied by different bands do not overlap. Within each band, timeline elements can be arranged and manipulated according to methods described in relation to FIGS. 11-14. It is understood that different layout methods may be used within a band. Unlike for containers, the same set of bands exists for a given view regardless of the position of the viewport and timeline elements that are currently visible. However, if, for a given band, there are no elements that are visible in the current viewport, such a band area may be collapsed (that is, a different visualization or no visualization at all).

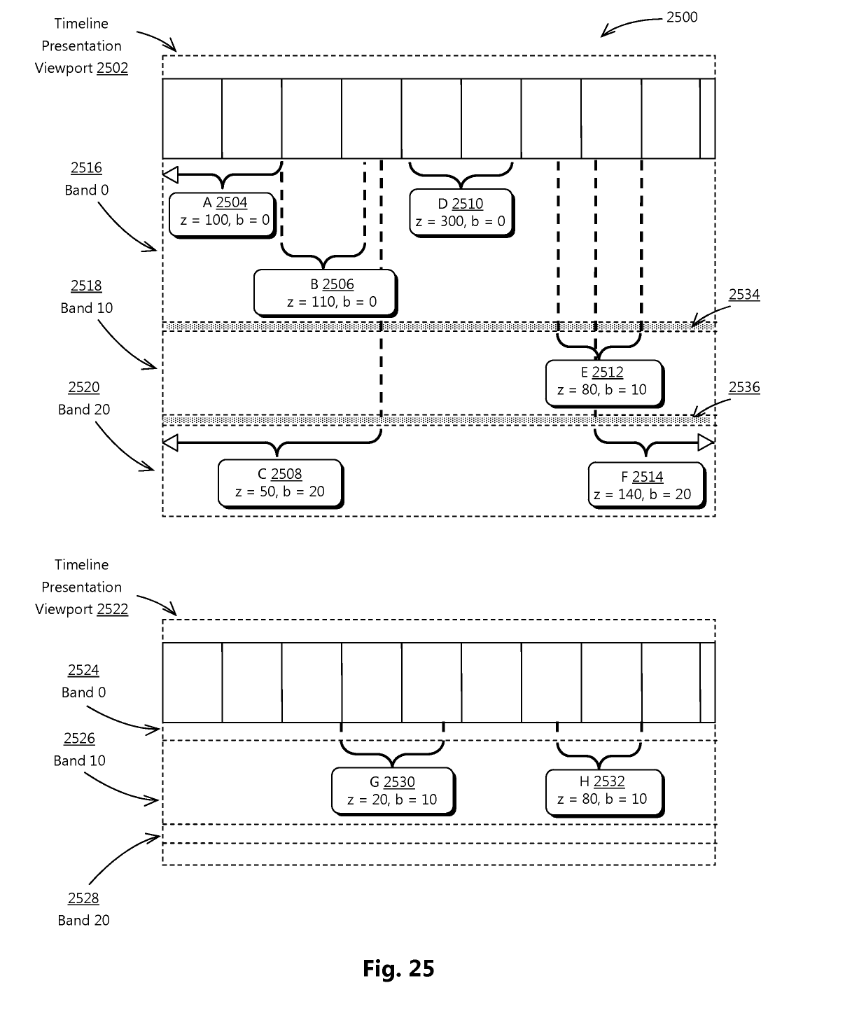

FIG. 25 illustrates an exemplary visualization 2500 for viewport 2502 in which timeline elements A 2504, B 2506, C 2508, D 2510, E 2512 and F 2514 are arranged between bands 2516, 2518 and 2520. Bands 2516, 2518 and 2520 in this example have identifiers 0, 10 and 20 respectfully and each of the timeline elements has at least one band ID assigned to it for a given view. It is understood that for different views of different set of bands may exist and a band assignment for the same element may be different for that view.

In this exemplary visualization, bands are ordered by their ID and occupy adjacent spaces within viewport content area. It is understood that this band order may be changed and visualization will be changed according to that order. In this exemplary visualization, areas between bands are occupied by band separator visualizations 2534 and 2536 to visually accent band arrangement. In this visualization, the area occupied by the band is determined by the elements currently visible for this band in the given viewport. It is seen from this example that element z-values and intersections do not affect band assignment and do not affect layout of elements in different bands. Within each band, elements are arranged according to methods discussed in relation to FIGS. 11-14. Other embodiments may provide different arrangement of band areas within the content area as well as different visualizations for band separators. Other embodiments may also use different layout methods within each band.

FIG. 25 also illustrates exemplary visualization of viewport 2522 of the same view but with different viewport parameters. In this visualization timeline elements G 2530 and H 2532 are assigned to band 2526, while for bands 2524 and 2528, there are no timeline elements visible in this view. Same set of bands is present for this viewport visualization, but in this embodiment, bands with no elements have collapsed visualizations. It is understood that different embodiments may provide different visualizations for bands with no visible elements.

### Adjusting Timeline Elements Arrangement Between Bands

A user may want to change the arrangement of timeline elements between bands to achieve the desired visual results and accent the logic when presenting a timeline. Thus, a method is presented for a user interface which may operate in conjunction with arrangement techniques discussed above in relation to FIGS. 11-14, 25 and manipulation techniques discussed above in relation to FIGS. 17-21. Such techniques allow changing arrangement of elements between bands using simple drag operations.

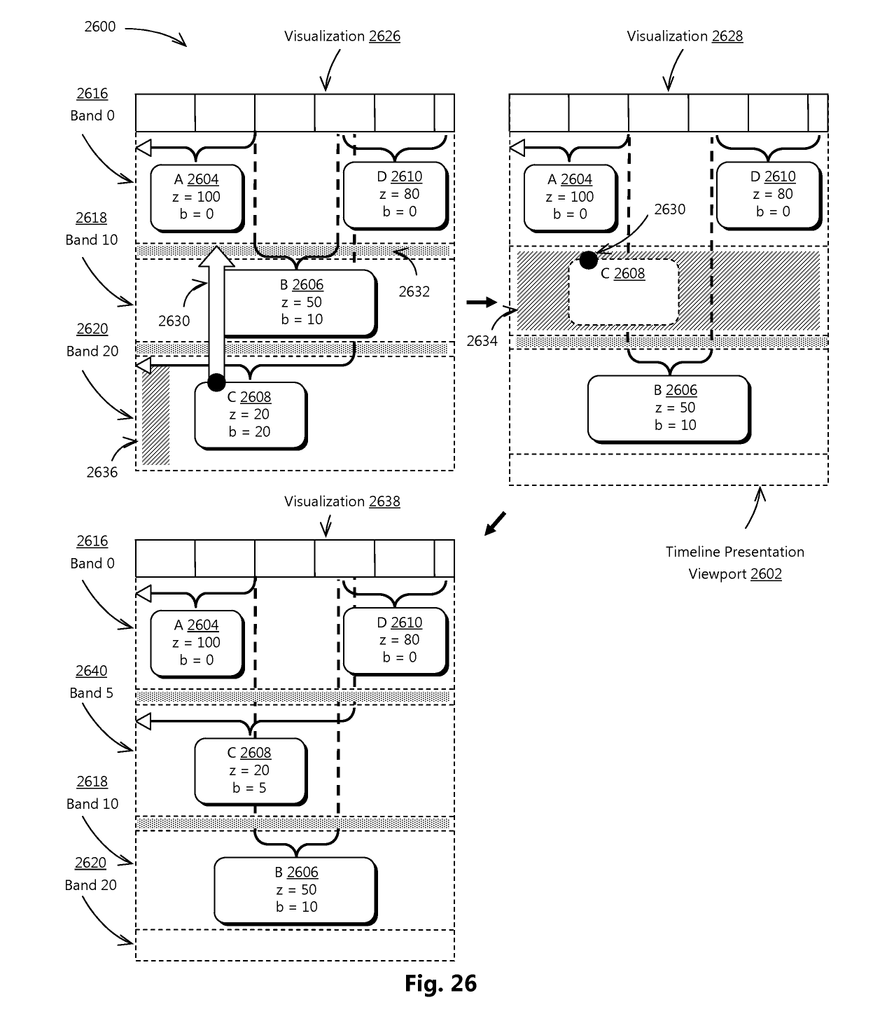

FIG. 26 illustrates an exemplary UI manipulation 2600 which takes place in viewport 2602 and allows placing timeline element C 2608 into a new band. Exemplary visualization 2626 shows timeline elements A 2604 and D 2610 in band 2616, element B in band 2618 and element C 2608 in band 2620.

A user may initiate a manipulation 2630 by selecting element C 2608 and dragging it over the viewport area. If the element is dragged to an area of different non-collapsed band then the ID of that band is temporarily assigned to the dragged element and a manipulation method described in relation to FIGS. 17-21 may be applied. When the element is dragged over the area of such band, the visualization 2636 may be displayed to accent the current band to which the manipulated element may be placed. The exact look of visualization 2636 may depend on particular embodiment. If the manipulation is finalized, the new band ID is recorded for the element in the current view. Further, it may be stored in the per-view element data table 1302 as described in relation to FIG. 13.

The element may also be dragged to the area of a band separator or to an area adjacent to the first band or last band, or to an area of a collapsed band. In each of these cases, a method for inserting a new band or expanding a collapsed band may be invoked. In the illustrated example, element C 2608 is dragged to the area of band separator 2632 between bands 2616 and 2618. In response to this action, the method may insert a temporary band 2640 between bands 2616 and 2618 and display visualization 2634 which accents the newly inserted band. The exact look of visualization 2634 may depend on particular embodiments. This produces visualization 2628 which, accordingly, re-arranges visualizations of existing bands 2616, 2618, and 2620 and their elements to accommodate temporary band. An ID of the temporary band 2640 is assigned to element C 2608 in this view. If manipulation is finalized, then the new band 2640 is created for this view, placed between the visualizations 2616 and 2628. Then, element C 2608 is assigned to the band 2640 in the current view. This produces the visualization 2638. If manipulation continues and the element is dragged away from the area of newly inserted band 2640, then this band visualization 2634 will be removed and remaining bands will be re-arranged accordingly. If the manipulation is cancelled, the temporary band and/or any temporary band assignments for the manipulated element are removed and the system returns to a state before manipulation.

If the manipulated element is dragged over the area of a collapsed band or over a separator of a collapsed band, then instead of inserting a new band, this method may expand one of the collapsed bands and offer a way to place the element into this expanded band. This technique may be used to avoid unintended increase of the number of bands by the user.

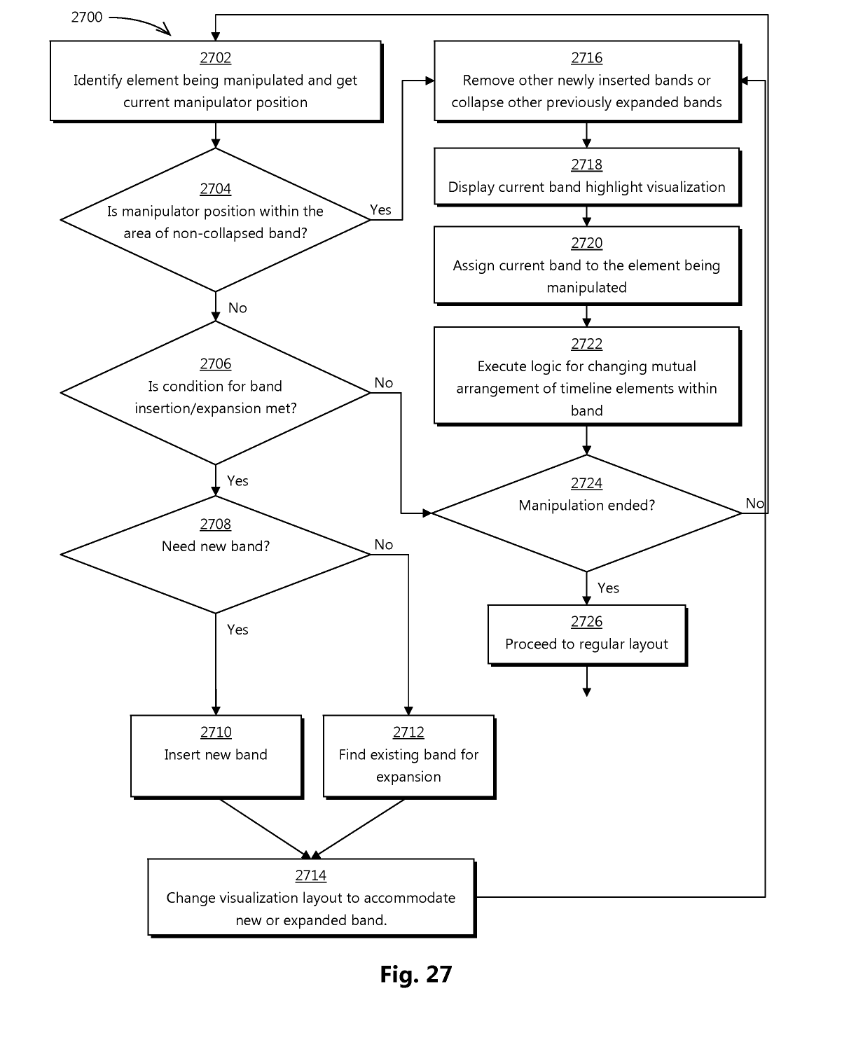

FIG. 27 is a flow diagram depicting an exemplary procedure 2700 for adjusting timeline element arrangement between bands. For this procedure, one may assume that minlevel for all elements remains fixed and not changed during manipulation. Elements selected by user for manipulation is determined as well as current manipulator (drag) position (block 2702). This information is derived from the parameters of drag operation. This approach may be repetitively applied to drag elements across multiple bands.

If the manipulator position is within the area of existing non-collapsed band (“yes” from decision block 2704), then the method removes any newly inserted band (if any) or collapses the temporarily expanded band (if any) (block 2716), displays current band highlight visualization (which includes hiding previous band highlight visualization, if it was displayed for a different band) (block 2720), temporarily assigns current band ID to the manipulated element in this view (block 2720) and proceeds to the in-band manipulator steps for mutual changing and mutual arrangement of elements between containers described in relation to FIGS. 17-21. If the manipulation is finalized (block 2724), then per-view element properties that were assigned as a result of this manipulation (including band ID) are recorded in per-view element data table (1302 of FIG. 13) and layout based on these parameters is performed (block 2726). If manipulation continues and an element is dragged beyond the boundary of existing band, then the method proceeds to block 2702.

If the manipulator position is not within the area of an existing non-collapsed band (“no” from decision block 2704), then the method evaluates whether conditions for band insertion/expansion is met. Conditions may be determined as follows:

If manipulator position is between two non-collapsed bands B1 and B2 (case A) or before the first non-collapsed band BF (case B) or after the last non-collapsed band BL (case C), then for this condition, the band is considered “collapsed” if it is currently collapsed in this viewport or if it will be collapsed in this viewport after manipulated element will be removed from it.

If one of these conditions is not satisfied (“no” from decision block 2706), then the method proceeds to block 2724. If at least one condition is satisfied (“yes”) from a decision block 2706, then the method checks whether a new band (block 2708) should be inserted. A new band will be inserted if:

Case A—there are no collapsed bands between B1 and B2, or

Case B—there are no collapsed bands before BH, or

Case C—there are no collapsed bands after BL.

If a new band should be inserted (“yes” from decision block 2708), then the method insert the new band between B1 and B2 in case A or before BF in case B or after BL in case C (block 2710) and proceeds to block 2714. If there is no need to insert new band (“no”) from a decision block 2708, then the method determines an existing band to expand. In case A, it will be one of the collapsed bands between B1 and B2, in case B it will be one of the bands before BF, in case C it will be one of the bands after BL (block 2712). Usually, the band picked for expansion will be the next collapsed band in the direction of drag, but this may depend on the implementation or embodiment. Then, the method changes bands visualization to accommodate for any new or expanded bands (block 2714). This includes rendering accent visualization for new or expanded bands. Depending on implantation or embodiment, visualization for newly inserted bands may be the same or different from the visualization for expanded band. Then, the method proceeds to block 2716.

### Optimized Vertical Layout for Timeline Elements in a Container

Since timeline element bubbles and brackets may have different heights and layout, different display and visualization methods may account for these differences to make more optimized use of space when rendering elements in containers of higher levels. In this illustrated example, horizontal layout is shown with respect to time and, thus, referred to as optimizing vertical space. It is understood that the same method can be applied to visualizations with different directions of layout.

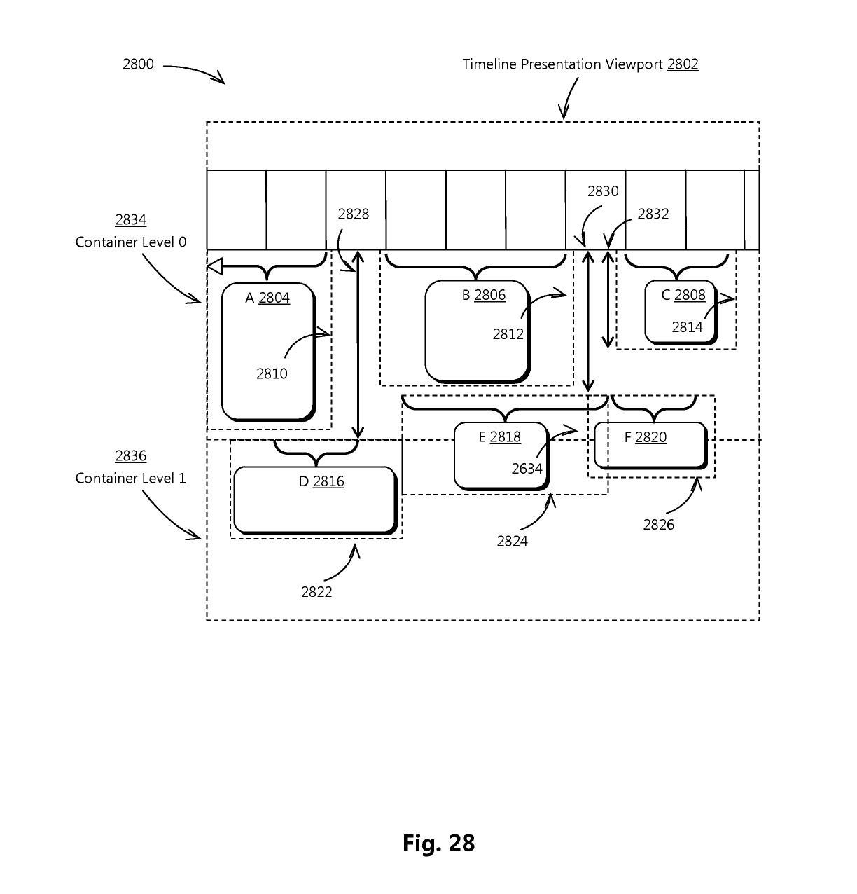

FIG. 28 illustrates an exemplary visualization 2800 of a timeline viewport 2802 which has two containers 2834 and 2836 and timeline elements A 2804 with bounding box 2810, B 2806 with bounding box 2812 and C 2808 with bounding box 2814 in container 2834 and timeline elements D 2816 with bounding box 2822, E 2818 with bounding box 2824 and F 2820 with bounding box 2820 in container 2836. Without changing the arrangement between containers, vertical position for elements D 2816, E 2818, and F 2820 can be adjusted to make optimized use of vertical space based on placement of elements in the previous container. Generally, this method positions elements in containers with higher indexes in such a way that the bounding box of each timeline element from container N+1 does not intersect the bounding box of any element in container N. The bounding box is the union of bubble rectangle and bracket rectangle in the visualization.

In the illustrated example, vertical positions increase toward the bottom of layout. In this example, vertical position of element D 2816 is set to height of 2828—the smallest value that does not intersect the bounding box of element A 2804, the one with which D 2816 has bounding box intersection horizontally. Similarly, vertical position for element E 2818 is set to height of 2830—the bottom edge of B 2806. However, vertical position for F 2820 is not set to the height of 2832, but also set for the height of 2830, because its bounding box overlaps with its container neighbor E 2818 and bringing it higher may cause bubble overlapping in the bracket.

A further method is presented for determining vertical positions for elements to achieve optimize vertical layout. It is understood that reference to vertical here is exemplary, and similar algorithms can be modified to accommodate different layout directions. In this method, layout for containers is performed starting with container 0. Layout for container 0 is accomplished without modifications as discussed in relation to FIGS. 7-10. For each subsequent container C, previous container PC is taken into account. Layout for container C takes place according to a method discussed in relation to FIGS. 7-10, except that vertical position is not constant for a container level. For each element in E, it is also taken into account its layout neighbor ELN which is the previous element that was laid out in container C. For the first element in the container layout, neighbor ELN is NULL (does not exist). Then, the following method is applied for each element E and its layout neighbor ELN in container C.

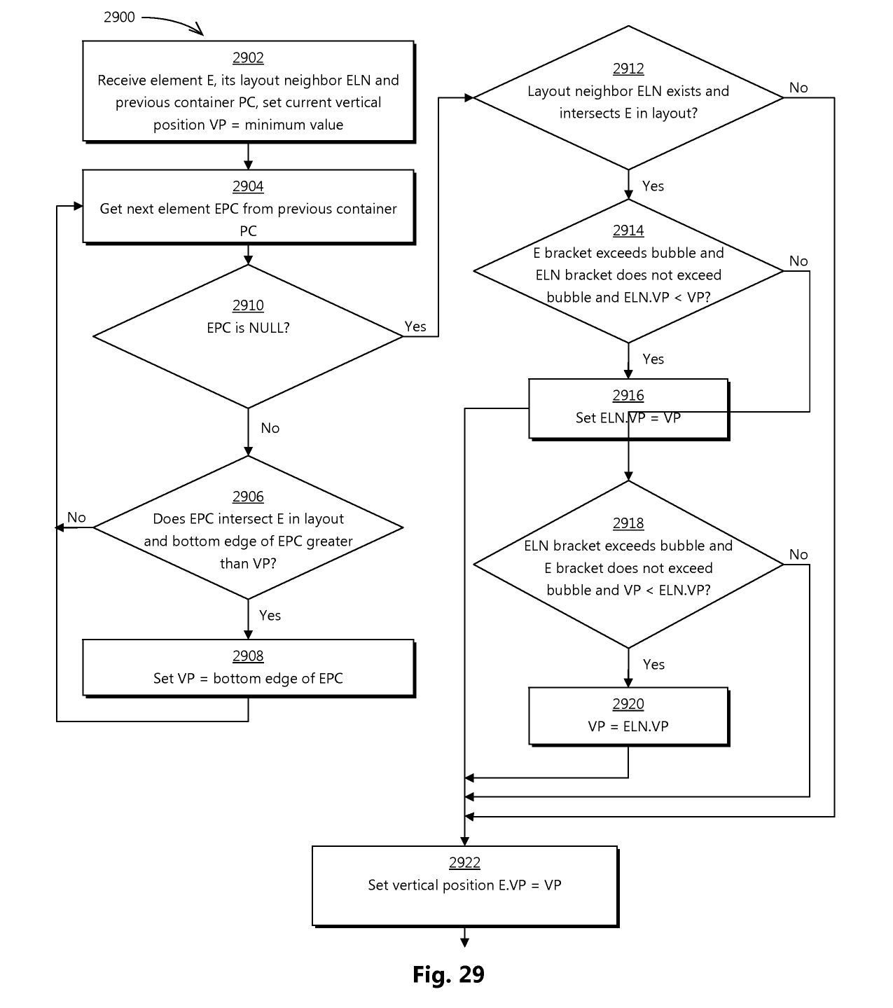

FIG. 29 is a flow diagram for an exemplary method 2900 for calculating vertical positions for timeline element E and its layout neighbor element ELN within container C. In this method, Element E may be identified along with an associated layout neighbor ELN and previous container PC (as stored in data table 1302 of FIG. 3). The method may set a current vertical position VP to a minimum value (which depends on the visual style of the element and embodiment) (block 2902). Then, the method may set an element iterator before the beginning of previous container PC and retrieve next element EPC from the previous container PC (block 2904). If EPC is NULL (e.g., no further elements in container PC) (“yes” from the decision block 2910), then the method proceeds to block 2912. If EPC is not NULL (“no” from the decision block 2910), then the method checks if EPC intersects with E in the layout and if the bottom edge of EPC is greater than VP (decision block 2906). In the scope of this exemplary method, “element A intersects element B in layout” means that bounding boxes of elements A and B would intersect if their top edges were aligned (in other words, if horizontal projections of the bounding boxes intersect in the layout). The bounding box of timeline element E is a union of the bracket bounding box and bubble bonding box in layout. Bounding boxes and their comparisons may include thresholds that are specific to implementation or embodiment. If condition 2906 is not met (“no” from decision block 2906), then the method proceeds to block 2902. If condition 2906 is met, then the method sets vertical position VP to the position of the bottom edge of EPC. Thresholds may apply depending on implementation or embodiment.

Once the iterations over the previous container PC is done, the method checks whether layout neighbor ELN exists and if it intersects E in layout. If not (“no” from the decision block 2912), then the method assigns a vertical position for E to the value of VP (block 2922) and ends. If layout neighbor ELN exists and if it intersects E in layout (“yes” from the decision block 2912), then the method checks if the bracket in element E exceeds the bubble and the bracket of layout neighbor ELN does not exceed the bracket and the vertical position of layout neighbor ELN is less than VP (decision block 2914). In the context of this exemplary method, “the bracket of element E exceeds the bubble” means that the horizontal size of the bracket bounding box for E exceeds the horizontal size of the bubble bounding box for E. If “yes” from the decision block 2914, then the method sets the vertical position for the layout neighbor ELN to VP (block 2916) and proceeds to block 2922. If “no” from the decision block 2914, then the method checks if the bracket of the ELN exceeds the bubble and the bracket of E does not exceed the bubble and VP is less than the vertical position of the ELN (decision block 2918). If this is not the case (“no from the decision block 2918), then the method proceeds to block 2922. If “yes” from the decision block 2918, then the method assigns VP to the vertical position of the layout neighbor VP (block 2920) and proceeds to block 2922.

### Default Assignment of Z-Values

A method is presented for default assignment of z-values to the timeline elements within given view. First, all timeline elements in a view are placed in a sequential list L, sorted first by the start time of the element, then (if start time is the same) by the identifier or by some other criteria (like creation time) which is generally dependent on the embodiment. Then, a sequential list CL of element containers is used, which starts empty. For each element E in the sorted list L procedure for determining z-value is executed, which receives element E and list CL. After this procedure is executed for all elements in L, these elements will have z-values assigned. Container list CL may be abandoned.

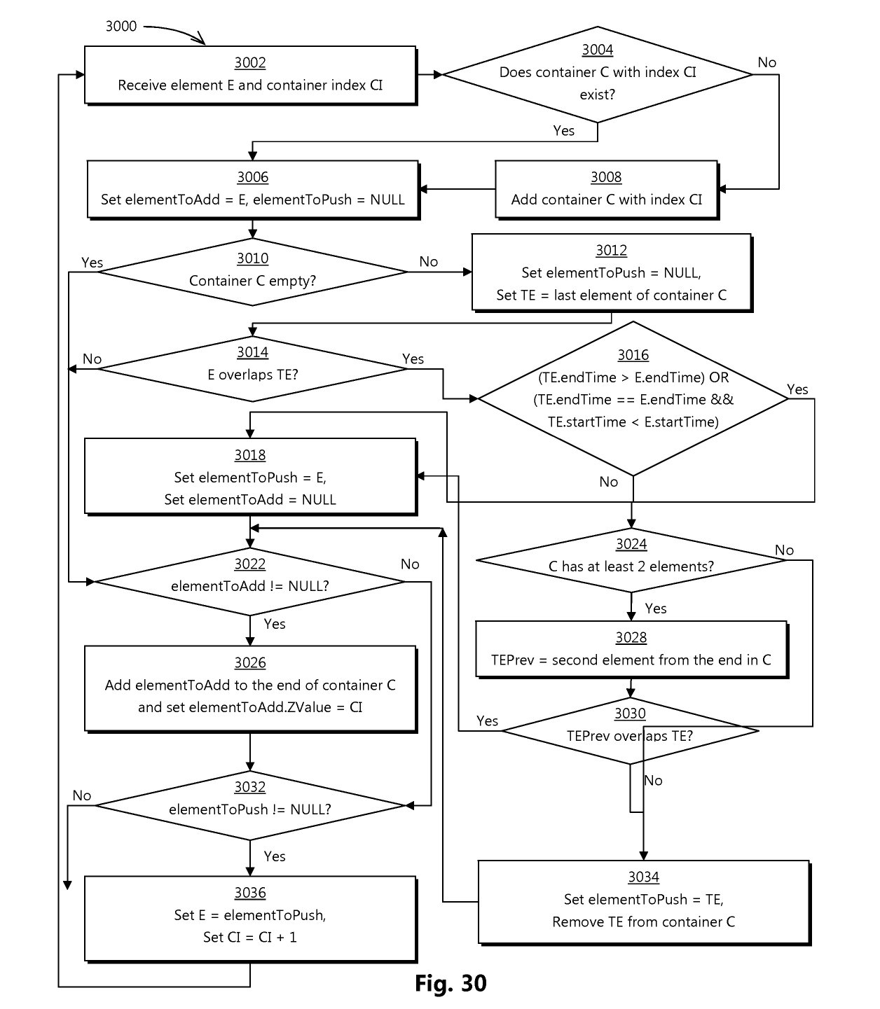

FIG. 30 is a flow diagram for an exemplary method 3000 for calculating z-value for a timeline element. In the context of this method “element E1 overlaps element E2” means that either time spans of E1 and E2 defined by properties startTime and endTime overlap or the horizontal projections of the bubble bounding boxes overlap. In this case, the bubble bounding box positions are calculated without respect to the viewport edges (see discussion in relation to FIGS. 7-10) assuming there is an infinitely wide viewport.

First, the method identifies element E and container index CI (block 3002). The method then checks if container C with index CI exists (block 3004). If so (“yes” from the decision 3004), then the method proceeds to block 3006. If not (“no” from the decision block 3004), then the method adds container C with index CI (block 3008) and proceeds to block 3006. The method may then set elementToAdd=E, elementToPush=NULL (block 3006) and check if container C is empty (block 3010). If “yes” from the decision block 3010, then the method checks if elementToAdd is not NULL (block 3022). If “yes” from the decision block 3022, then the method adds elementToAdd to the end of container C and set elementToAdd.ZValue=CI (block 3026). Then, the method checks if elementToPush is not NULL (block 3032). If “no” from decision block 3032, then the method ends. If “yes” from decision block 3032, then the method sets E=elementToPush, set CI=C+1 and proceeds to block 3002. If “no” from decision block 3022 then the method proceeds to block 3032.

If “no” from decision block 3010, then the method sets elementToPush=NULL, set TE=last element of container C. Then the method checks if E overlaps TE (block 3014). If “no” from the decision block 3014, then the method proceeds to block 3022. If “yes” from the decision block 3014, then the method checks if TE.endTime>E.endTime OR (TE.endTime==E.endTime && TE.startTime<E.startTime) (block 3016). If “no” from block 3016, then the method proceeds to block 3018. If “yes” from block 3016 then, the method checks if container C has at least two elements (block 3024). If “no” from decision block 3024, then the method sets elementToPush=TE, remove TE from container C (block 3034) and proceeds to block 3022. If “yes” from decision block 3024 the set TEPrev=second element from the end in container C (block 3028). Check if TEPrev overlaps TE (block 3030). If “yes” from the decision block 3030, then the method proceeds to block 3018. If “no” from decision block 3030 then the method proceeds to block 3034.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A computing system, comprising:
a data store having a plurality of timeline elements stored therein, each timeline element associated with data about the timeline element and associated with a context for the timeline element;
a processor coupled to the data store and configured to cause display of at least one timeline element with its associated data and its associated context; and
an application, executable by the processor, configured to determine a layout for the display of the timeline elements such that associated contexts of timeline elements do not interfere with each other.

2. The computing system of claim 1, wherein the data associated with each timeline element further comprises:
a time span;
a start time;
an end time;
style information; and
user-defined information.

3. The computing system of claim 1, wherein the context associated with each timeline element further comprises:
a view identification;
an element identification;
a z-value;
a band identification; and
a minimum level value.

4. The computing system of claim 1, wherein the application further comprises a timeline visualization and interaction module configured to:
receive input from a user for manipulating view parameters and manipulating timeline elements displayed in a content area;
determine an interaction between a first timeline element and a second timeline element as a result of the user input; and
display the first and second timeline element according to the determination.

5. The computing system of claim 4, wherein the timeline visualization and interaction module is further configured to display each timeline element with associated geometries and user content and within one of a plurality of containers.

6. The computing system of claim 4, wherein the timeline visualization and interaction module is further configured to display each timeline element in a view according to a timeline element data, view parameters and a context associated with the timeline element and the view.

7. The computing system of claim 4, wherein the timeline visualization and interaction module is further configured to display a plurality of timeline elements within a plurality of containers and within a plurality of bands such that no timeline element visualization interferes with any other timeline element visualization.

8. The computing system of claim 4, wherein the timeline visualization and interaction module is further configured to change the display of a timeline element according to the display of one or more other timeline elements displayed in the current view.

9. The computing system of claim 4, wherein the timeline visualization and interaction module is further configured to change the display of a timeline element if a current view displayed cannot show a full breadth of the timeline element.

10. The computing system of claim 4, wherein the timeline visualization and interaction module is further configured to change the data and context of one or more timeline elements in response to a select and drag input by a user.

11. The computing system of claim 4, wherein the timeline visualization and interaction module is further configured to change the display of one or more timeline elements in response to a change in the data and context associated with the one or more timeline elements.

12. The computing system of claim 4, wherein the timeline visualization and interaction module is further configured to change the parameters of a timeline view in response to a select and drag input by a user.

13. A method for displaying timeline data on a computing display, the method comprising:
reading data from a data store of timeline elements, each timeline element having associated data and an associated context; displaying the data associated with the read timeline elements according to the associated context;
determining if any timeline elements has an associated context that would interfere with the associated context of any other timeline element when displayed; and
if an interference is determined; changing the display of one of the timeline elements according its associated context in relation to the other.

14. The method of claim 13, wherein changing the display further comprises changing a container in which a timeline element is displayed.

15. The method of claim 13, wherein changing the display further comprises changing a position of a timeline element being displayed.

16. The method of claim 13, wherein changing the display further comprises changing visualization of a bubble of a timeline element being displayed.

17. The method of claim 13, wherein changing the display further comprises changing visualization of a bracket of a timeline element being displayed.

18. The method of claim 13, wherein changing the display further comprises changing data in the data store as a result of the determination of interference.

19. The method of claim 13, wherein changing the display further comprises changing the data in the data store in response to a user input.

20. A non-transitory computer-readable medium having computer-executable instruction stored therein, the computer-executable instructions, when executed by a computer, causing the computer to:
read data from a data store of timeline elements, each timeline element having associated data and an associated context;
display the data associated with the read timeline elements according to the associated context;
determine if any timeline elements has an associated context that would interfere with the associated context of any other timeline element when displayed; and
if an interference is determined; change the display of one of the timeline elements according its associated context in relation to the other.

21. The computer system of claim 1, wherein the layout further comprises a timeline presentation viewport having a timeline bar having a plurality of timeline blocks.

22. The computer system of claim 21, wherein each timeline block comprises a start time and an end time.

23. The computer system of claim 22, wherein each timeline block is displayed with respect to the timeline bar, and
if a first block comprises a start time the corresponds to an end time of a second block, displaying the first and second blocks adjacent to each other; and
if the first time block comprises an end time that does not correspond to any other start time of any other block, then displaying a gap block adjacent to the first block.

24. The computer system of claim 23, further comprising a manipulator configured to manipulate a gap block in response to a use input and configured to manipulate the timeline bar in response to a user input.
